(19) United States
(12) Patent Application Publication
(10) Pub. No.: US 2026/0257759 A1
(43) Pub. Date: Sep. 3, 2026

(54) DRIVE UNIT AND ELECTRIC VEHICLE

(71) Applicant: Panasonic Intellectual Property Management Co., Ltd., Osaka (JP)

(72) Inventor: Masafumi KAWAKAMI, Nara (JP)

(73) Assignee: Panasonic Intellectual Property Management Co., Ltd., Osaka (JP)

(21) Appl. No.: 18/872,812

(22) PCT Filed: Aug. 18, 2023
(86) PCT No.: PCT/JP2023/029791

§ 371 Date: Dec. 7, 2024

(30) Foreign Application Priority Data
Sep. 14, 2022 (JP) 2022-146532

(51) Int. Cl. B62M 6/55; B62J 45/411; B62J 45/421; B62M 11/14; B62M 11/18; H02K 7/108; H02K 7/116; H02K 13/00

(52) U.S. Cl. CPC B62M 6/55; B62J 45/411; B62J 45/421; B62M 11/145; B62M 11/18; H02K 7/108; H02K 7/116; H02K 13/003

(57) ABSTRACT

A drive unit according to one example of an embodiment comprises: a motor; a housing; a crank shaft protruding from the housing and rotatably attached to the housing; an output body which outputs the torque of the motor; and a power transmission mechanism which transfers the torque of the motor to the output body. In addition, the crank shaft has therein a hollow section and at least a portion of the power transmission mechanism is accommodated in the hollow section.

### TECHNICAL FIELD

The present disclosure relates to a drive unit and an electric vehicle comprising a drive unit.

### BACKGROUND ART

As a drive unit used in an electric vehicle, there is conventionally known a drive unit comprising a motor and a motive power transmission mechanism that transmits rotation force of the motor. Patent Literature 1 discloses a drive unit in which a motive power transmission mechanism includes a planetary gear mechanism.

### CITATION LIST

### Patent Literature

PATENT LITERATURE 1: U.S. Pat. No. 10,035,561

### SUMMARY

The drive unit disclosed in Patent Literature 1 aims to increase outputs of the drive unit, by disposing a motor on the radially outer side of a crankshaft and allowing the motor to have a larger diameter. However, miniaturizing the drive unit is not taken into consideration, and there is room for improvement with respect to the miniaturization. Regarding drive units used in electric vehicles, miniaturization of the drive units is an important goal.

A drive unit used in an electric vehicle according to an aspect of the present disclosure comprises: a motor; a housing; a crankshaft that protrudes from the housing and is rotatably attached to the housing; an output element that outputs rotation force of the motor; and a motive power transmission mechanism that transmits the rotation force of the motor to the output element. The crankshaft has a hollow part, and at least a part of the motive power transmission mechanism is housed in the hollow part.

The drive unit according to the present disclosure makes the miniaturization of the drive unit possible. Although being compact, the drive unit according to the present disclosure exhibits sufficient output characteristics as a drive source of the electric vehicle.

### BRIEF DESCRIPTION OF DRAWING

FIG. 1 is a drawing showing an external appearance of an electric assist bicycle according to an example of a first embodiment.

FIG. 2 is a sectional view of a drive unit according to the first embodiment.

FIG. 3 is an enlarged sectional view of a left section in the vicinity of a crankshaft of the drive unit according to the first embodiment.

FIG. 4 is an enlarged sectional view of a right section in the vicinity of the crankshaft of the drive unit according to the first embodiment.

FIG. 5 is an exploded perspective view of the drive unit according to the first embodiment.

FIG. 6 is a perspective view of a crankshaft of the drive unit according to the first embodiment.

FIG. 7 is a perspective view of a human power transmitter of the drive unit according to the first embodiment.

FIG. 8 is a perspective view of an output element of the drive unit according to the first embodiment.

FIG. 9 is a sectional view taken at line A-A in FIG. 3.

FIG. 10 is a sectional view taken at line B-B in FIG. 4.

FIG. 11 is a sectional view taken at line C-C in FIG. 4.

FIG. 12 is an enlarged sectional view of the vicinity of a crankshaft according to a modification example of the drive unit of the first embodiment.

FIG. 13 is a sectional view taken at line D-D in FIG. 12.

FIG. 14 is a perspective view of a control substrate according to the first embodiment.

FIG. 15 is a perspective view of an energization unit according to the first embodiment.

FIG. 16 is a perspective view of the crankshaft and a crank arm according to the first embodiment.

FIG. 17 is a sectional view of a fixation component part for the crank arm according to the first embodiment.

FIG. 18 is a sectional view of a drive unit according to a second embodiment.

FIG. 19 is an enlarged sectional view of the vicinity of a crankshaft of the drive unit according to the second embodiment.

FIG. 20 is a perspective view of a housing of the drive unit according to the second embodiment.

FIG. 21 is a sectional view of a drive unit according to a third embodiment.

FIG. 22 is a sectional view of a drive unit according to a fourth embodiment.

FIG. 23 is a sectional view of a drive unit according to a fifth embodiment.

FIG. 24 is a sectional view of a drive unit according to a sixth embodiment.

### DESCRIPTION OF EMBODIMENTS

The following will describe embodiments of a drive unit and an electric vehicle comprising the drive unit of the present disclosure in detail. The embodiments described below are merely examples, and the present disclosure is not limited to the following embodiments. Further, embodiments obtained by selectively combining any of the plurality of embodiments and modification examples described below are included in the present disclosure.

### First Embodiment

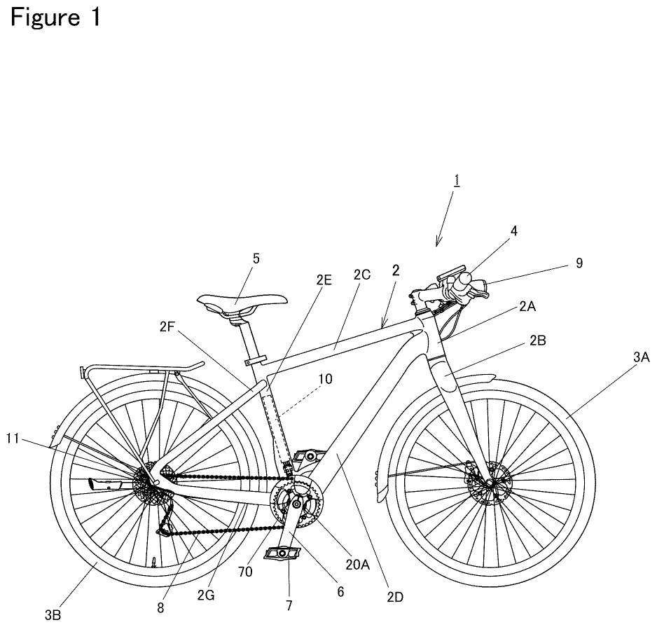

The following will describe a first embodiment of the drive unit and the electric vehicle of the present disclosure, with reference to FIGS. 1 to 17.

FIG. 1 is a right side view showing an external appearance of an electric assist bicycle 1 being an electric vehicle of the first embodiment. Possible electric vehicles of the present disclosure are not limited to the electric assist bicycle 1 and include any electric vehicle that travels with motive power of a motor. Further, the electric assist bicycle 1 of the present disclosure is not limited to a sports bicycle such as that shown in FIG. 1 and may be a city bicycle, a folding bicycle, or the like, for example. In the embodiments of the present disclosure, the terms front/rear, left/right, top/bottom, and up/down denote the front/rear, left/right, top/bottom, and up/down directions based on the state in which a rider is sitting on the saddle of the electric assist bicycle 1 facing the handlebar.

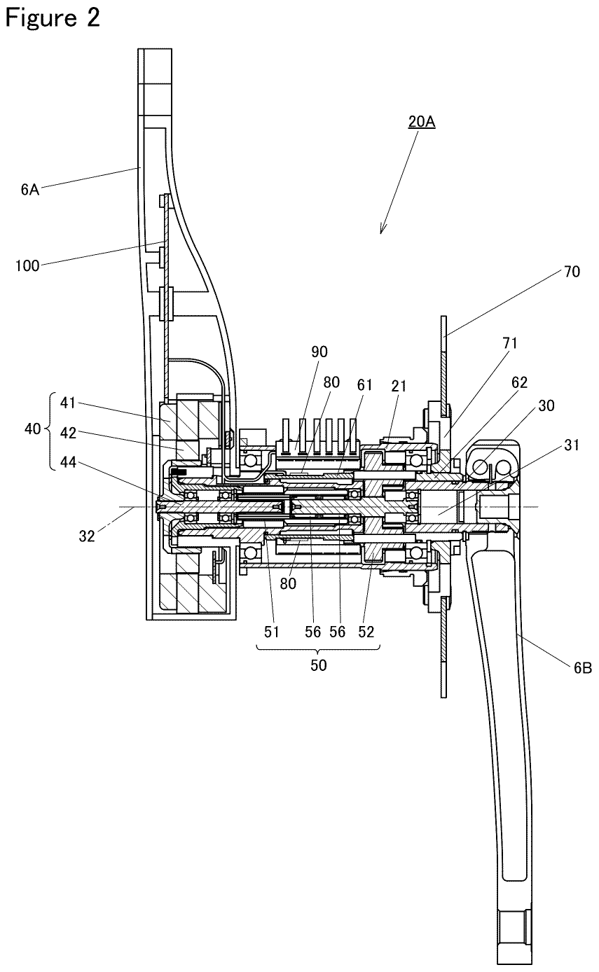

The electric assist bicycle 1 comprises a drive unit 20A and an electric power storage device 10 that supplies electric power to the unit and has a function of providing assistance for the rider's driving force (human driving force) from pedaling, with motive power of a motor 40 (see FIG. 2 described later) of the drive unit 20A. Similarly to generic bicycles, the electric assist bicycle 1 comprises a frame 2, a front wheel 3A, a rear wheel 3B, a handlebar 4, a saddle 5, and a front light 9.

The frame 2 is a framework connecting together the front wheel 3A, the rear wheel 3B, the handlebar 4, the saddle 5, and the like. The frame 2 is structured with a plurality of pipes. Provided as the plurality of pipes are: a head pipe 2A, a front fork 2B, a top pipe 2C, a down pipe 2D, a seat pipe 2E, a seat stay 2F, a chain stay 2G, and a bottom bracket (not shown). A bottom bracket hanger is a location where the down pipe 2D, the seat pipe 2E, and the chain stay 2G are joined together.

The drive unit 20A comprises a pair of crank arms 6 to each of which a pedal 7 is attached. The crank arms 6 are provided one each on the left and on the right of the electric assist bicycle 1. On the inside of each of the crank arms 6, a space is formed for housing therein the motor 40 and the like (described later). While the pedal 7 is attached to one of the ends of each of the pair of crank arms 6, the other ends of the pair of crank arms 6 are connected to each other by a crankshaft 30 (see FIG. 2). The drive unit 20A has a front sprocket 70. The electric assist bicycle 1 comprises a chain 8, as a motive power transmission mechanism that transmits rotation force of the front sprocket 70 to the rear wheel 3B. The chain 8 connects the front sprocket 70 to a rear wheel sprocket 11 provided for the rear wheel 3B. Alternatively, the front sprocket 70 may be connected to the rear wheel sprocket 11 by a belt or a shaft drive.

The electric power storage device 10 is an electric power source device that supplies electric power to an energization unit 90 (described later) of the drive unit 20A.

As shown in FIG. 1, the electric power storage device 10 is housed in the seat pipe 2E.

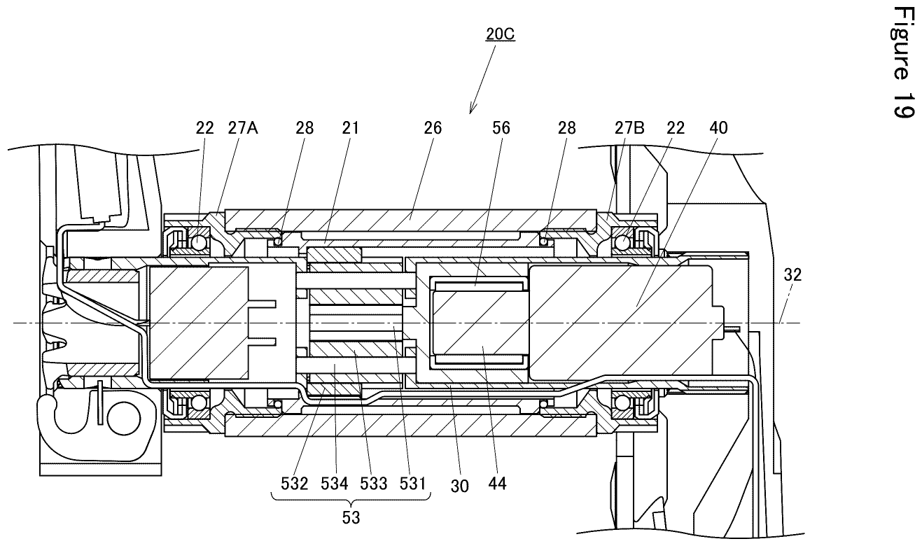

As for positioning thereof, the electric power storage device 10 may be installed in the seat pipe 2E or may be installed in the top pipe 2C or the down pipe 2D. Further, as described in a second embodiment (described later; see FIG. 19 below), the electric power storage device 10 may be housed in a rotating object such as a crank arm 6 or a pedal 7. As the electric power storage device 10, a secondary battery may preferably be used, but a primary battery may also be used instead. The electric power storage device 10 may preferably have voltage greater than or equal to 12 V and less than or equal to 48 V. Further, the electric power storage device 10 may be provided with a voltage conversion circuit. The voltage conversion circuit may be provided inside the electric power storage device 10 or may be provided outside the electric power storage device 10.

Next, the drive unit 20A according to the first embodiment will be described, with reference to FIG. 2. FIG. 2 is a sectional view of the drive unit 20A.

The drive unit 20A is a driving unit that provides assistance for pedaling force from the pedals 7. As shown in FIG. 2, the drive unit 20A comprises: the motor 40 that gives rotation force to provide assistance for the pedaling force from the pedals 7; a housing including a cover 21; and the crankshaft 30 rotatably attached to the cover 21. The drive unit 20A further comprises: an output element 62 that outputs the rotation force of the motor 40; and a motive power transmission mechanism 50 that transmits the rotation force of the motor 40 to the output element 62. The motive power transmission mechanism 50 includes a first planetary gear mechanism 51, a second planetary gear mechanism 52, and two one-way clutches 56.

The crankshaft 30 penetrates the cover 21 in the direction along a central axis 32. In this situation, the central axis 32 is a rotation axis of the crankshaft 30 that passes through the radial center of the crankshaft 30. The crankshaft 30 is a tubular member that has a hollow part 31 on the inside thereof. The hollow part 31 houses therein at least a part of the motive power transmission mechanism 50. While comprising the motive power transmission mechanism 50, this configuration makes it possible to miniaturize the drive unit 20A. In other words, it is possible to realize the drive unit 20A that is miniaturized, while guaranteeing capabilities related to a reduction ratio and the like that are required when the electric assist bicycle 1 is ridden.

The motor 40 comprises a stator 41, a rotor 42, and a motor shaft 44 that rotates together with the rotor 42. The motor 40 is housed inside a left crank arm 6A and in the hollow part 31 inside the crankshaft 30. With this configuration, it is possible to miniaturize the drive unit 20A, while keeping the motor 40 in a sufficient size. In other words, it is possible to realize the drive unit 20A that is miniaturized while exhibiting sufficient output characteristics as a drive source of the electric assist bicycle 1.

As described above, the drive unit 20A comprises the pair of crank arms 6 to each of which a different one of the pedals 7 is attached. The pair of crank arms 6 are connected to the two ends of the crankshaft 30. The crankshaft 30 is rotated by the driving force (human driving force) from the pedaling force applied to the pedals 7.

The drive unit 20A further comprises a human power transmitter 61 attached so as to rotate integrally with the crankshaft 30. The human power transmitter 61 is a tubular member extending in the direction along the central axis 32 of the crankshaft 30 and is disposed in the cover 21 along an outer circumferential part of the crankshaft 30. An inner circumferential part at the left end of the human power transmitter 61 is fitted with the outer circumferential part of the crankshaft 30. As a result, the human power transmitter 61 rotates integrally with the crankshaft 30. Further, an outer circumferential part at the right end of the human power transmitter 61 is fitted with an inner circumferential part at the left end of the output element 62. As a result, the output element 62 rotates integrally with the human power transmitter 61.

The drive unit 20A further comprises the front sprocket 70. The front sprocket 70 is fixed to the output element 62 and outputs the rotation force of the motor 40. The front sprocket 70 and the rear wheel sprocket 11 (see FIG. 1) are connected together via the chain 8 (see FIG. 1), as described above.

An overview of a motive power transmission path of the drive unit 20A can be described as follows. First, a motive power transmission path for the human driving force applied to the pedals 7 will be described. As a result of a rider pedaling on the pedals 7 of the electric assist bicycle 1, the crankshaft 30 rotates in the forward direction. In this situation, rotating in the forward direction denotes rotating in the direction to cause the electric assist bicycle 1 to move forward. When the crankshaft 30 rotates in the forward direction, the human power transmitter 61 fitted with the outer circumferential part of the crankshaft 30 rotates in the forward direction integrally with the crankshaft 30. Further, rotation force of the human power transmitter 61 to rotate in the forward direction is transmitted to the output element 62 that outputs the rotation force of the motor 40. Further, the output element 62 and the front sprocket 70 fixed to the output element 62 integrally rotate in the forward direction. When the front sprocket 70 rotates in the forward direction, rotation force in the forward direction is applied to the rear wheel sprocket 11 via the chain 8, and thus, the rear wheel sprocket 11 and the rear wheel 3B rotate in the forward direction. As a result, the electric assist bicycle 1 moves forward.

Next, a motive power transmission path for the rotation force of the motor 40 will be described. When the motor shaft 44 of the motor 40 rotates in the forward direction, the rotation force is transmitted to the output element 62 via the motive power transmission mechanism 50 including the first planetary gear mechanism 51, and the second planetary gear mechanism 52 (described later). In other words, the output element 62 functions as a combining element that combines the rotation force from the human power transmitter 61 described above, with the rotation force of the motor 40. The rotation force of the motor 40 transmitted to the output element 62 is transmitted to the rear wheel 3B through the same motive power transmission path as that used by the aforementioned human driving force, and the electric assist bicycle 1 thus moves forward.

The drive unit 20A further comprises: one or more torque sensors 80 that detect torque of the human driving force; and a control device 100 for realizing an appropriate electric assist function, by controlling outputs of the motor 40 in accordance with the detected torque.

The torque sensors 80 are provided in an outer circumferential part of the human power transmitter 61 and detect strain occurring on the human power transmitter 61. As each of the torque sensors 80, for example, a strain sensor that detects physical strain or a strain sensor that detects magnetic strain may be used. Further, for example, it is also acceptable to use a scheme by which paint that emits light in response to a mechanical stimulation is applied to an outer circumferential part of the human power transmitter 61, so that an optical sensor detects the light. By providing the torque sensors 80 in the outer circumferential part of the human power transmitter 61, it is possible to detect the torque acting on the left and the right crank arms 6.

In the drive unit 20A, two torque sensors 80 in total are provided, so that one each is disposed at positions opposite to each other with respect to the circumferential direction of the outer circumferential part of the human power transmitter 61. Alternatively, only one torque sensor 80 or three or more torque sensors 80 may be provided in the outer circumferential part of the human power transmitter 61. Further, possible installation locations of the one or more torque sensors 80 are not limited to the outer circumferential part of the human power transmitter 61 and, for example, may be provided for the crankshaft 30, the crank arms 6, or a spider arm 71. In an example, it is also acceptable to provide each of the left and the right crank arms 6 with the torque sensor 80 so as to detect or calculate the torque of the human driving force applied to the left and the right pedals 7. In another example, it is also acceptable to provide a rear wheel hub with the torque sensor 80 so as to detect the torque of the human driving force by subtracting torque of the motor 40.

For example, the control device 100 is a control substrate on which a microcomputer or the like is mounted. Based on the torque detected by the torque sensors 80, the control device 100 controls the rotation of the motor 40. Any of various types of devices may be used as the control device 100 as appropriate, and detailed descriptions thereof will be omitted. For communication between the torque sensors 80 and the control device 100, a signal line may be used or wireless communication may be used. For example, signals from the torque sensors 80 may be wirelessly transmitted to the control device 100 by using a contactless electric power supply circuit. In another example, it is also acceptable to install an electric power storage device for the torque sensors 80, so as to transmit the signals from the torque sensors 80 to the control device 100 by using a wireless communication device (Bluetooth or ant+). In that situation, the electric power storage device for the torque sensors 80 may be provided inside the crankshaft 30 or may be arranged with the crank arms 6. In addition, it is also acceptable provide an amplification circuit that amplifies the signals from the torque sensors 80.

Possible installation locations of the control device 100 are not particularly limited. For example, the control device 100 may be housed in the left crank arm 6A as shown in FIG. 2 or may be installed in an outer circumferential part of the housing. In another example, the control device 100 may be housed inside the frame 2 (see FIG. 1). When the motor 40 is housed in the crank arm 6 or the crankshaft 30, the control substrate may preferably be housed in the crank arm 6 or the crankshaft 30. This configuration makes electrical connection between the control substrate and the motor 40 easier.

The control substrate may be structured using a single substrate or may be structured using a plurality of substrates. By using a plurality of control substrates, because it is possible to keep each of the substrates compact, it is possible to easily house the control substrates in a small space. Further, a plurality of control substrates may be housed in each of the left and the right crank arms 6.

The drive unit 20A further comprises an energization unit 90. The energization unit 90 supplies electric power from the electric power storage device 10 (see FIG. 1) housed in the frame 2 to devices such as the motor 40 housed in the crankshaft 30 or the left crank arm 6A. Details of the energization unit 90 will be described later.

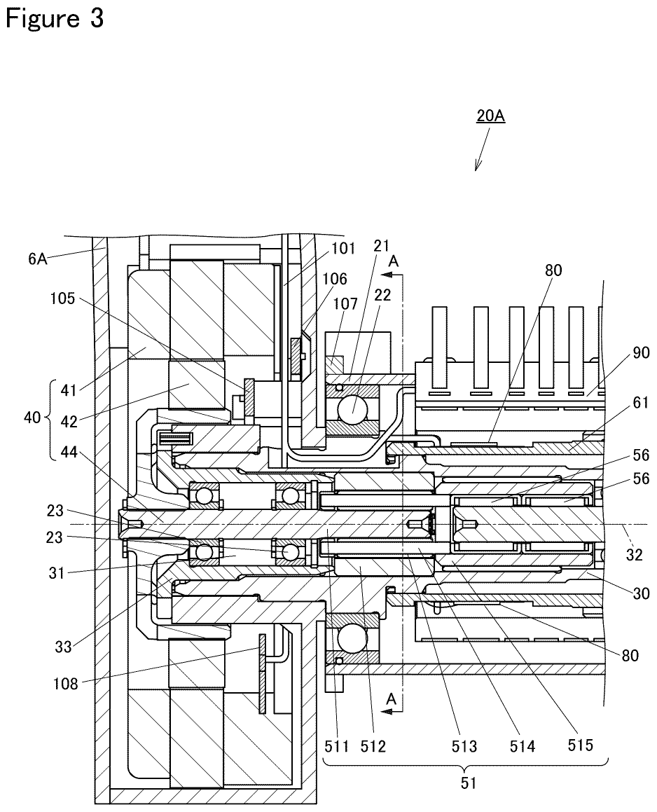

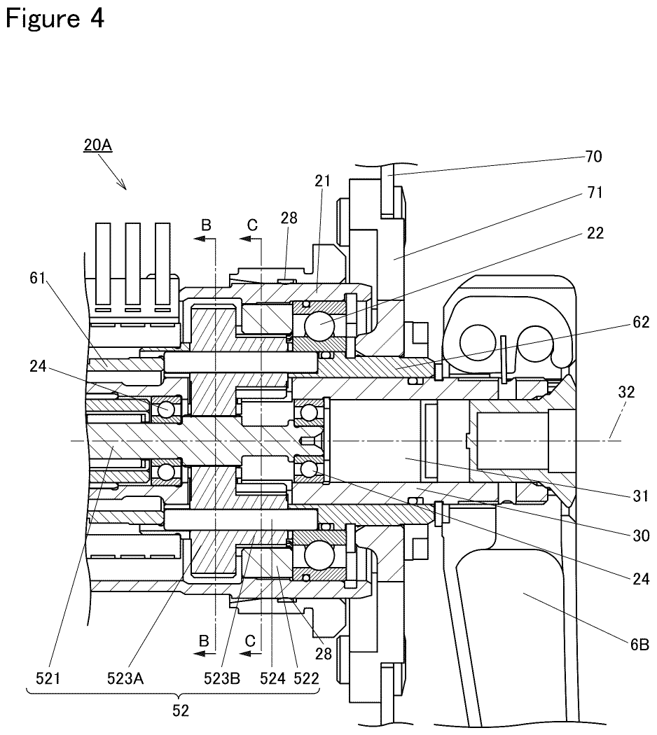

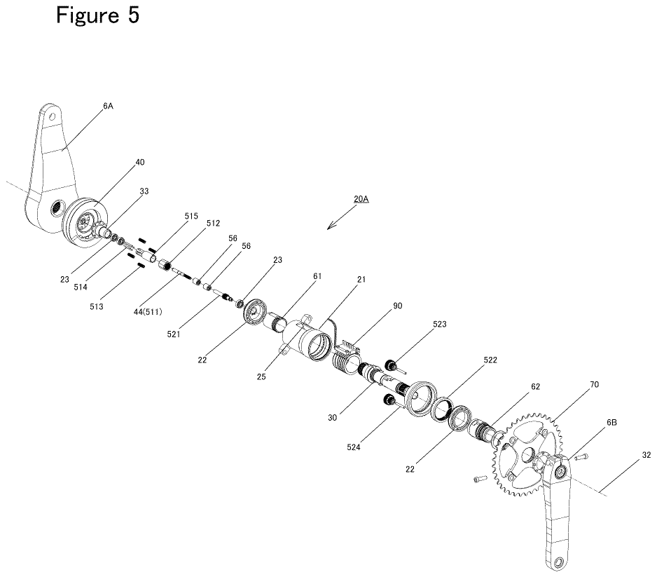

Next, the drive unit 20A will be described further in detail, with reference to FIGS. 3 to 5. FIG. 3 is an enlarged sectional view of a left section of the drive unit 20A. FIG. 4 is an enlarged sectional view of a right section of the drive unit 20A. FIG. 5 is an exploded perspective view of the drive unit 20A.

As shown in FIGS. 3 to 5, the drive unit 20A comprises: the crankshaft 30 having the hollow part 31; and the left crank arm 6A and a right crank arm 6B connected to the two ends of the crankshaft 30. A space is formed on the inside of the left crank arm 6A. The spaces inside the left crank arm 6A and the hollow part 31 are joined together.

As shown in FIG. 3, the left crank arm 6A houses therein the motor 40, a rotor rotation detection substrate 105 used for reading the rotation of the motor 40, and a crankshaft rotation detection substrate 106 used for reading the rotation of the crankshaft 30. As shown in FIG. 3 and FIG. 4, the hollow part 31 inside the crankshaft 30 houses therein, starting from the left side, the motor shaft 44, the first planetary gear mechanism 51, the one-way clutches 56, and a part of the second planetary gear mechanism 52.

Further, the hollow part 31 houses therein a bearing 23 that supports the motor shaft 44 so as to be rotatable on the central axis 32; and bearings 24 that support a sun gear 521 included in the second planetary gear mechanism 52 so as to be rotatable on the central axis 32.

The human power transmitter 61 and the output element 62 are attached to the outer circumferential part of the crankshaft 30. The human power transmitter 61 and the output element 62 are attached so as to rotate integrally with the crankshaft 30. The two torque sensors 80 are provided in the outer circumferential part of the human power transmitter 61.

The cover 21 is provided on the radially outer side of the crankshaft 30. The cover 21 houses therein the human power transmitter 61 and the left side of the output element 62. Further, two bearings 22 that support the crankshaft 30 so as to be rotatable on the central axis 32 are housed inside the cover 21. In a central part of the cover 21, the energization unit 90 is inserted and fixed. Further, the energization unit 90 and the control device 100 are connected together by an energization member 101.

The housing forms an outer shell of the drive unit 20A. In the present embodiment, the housing includes the cover 21 and the bottom bracket. The cover 21 is a tubular member that extends in the direction along the central axis 32 of the crankshaft 30. As shown in FIG. 19 (described later), the cover 21 is housed inside the bottom bracket of the electric assist bicycle 1 and is fixed to the bottom bracket by a screw or the like. Alternatively, the cover 21 and the bottom bracket may be structured integrally. In other words, it is also acceptable to provide only a bottom bracket, without providing the cover 21. Further, at the time of fixing the cover 21 to the bottom bracket, a buffer 28 may preferably be provided between the cover 21 and a fixation member. For example, as the buffer 28, either a ring made of resin or an adhesive agent having elasticity may be used. By providing the buffer 28, it is possible to prevent squeaking noise that is caused when the cover 21 comes into contact with screw members 27.

As shown in FIG. 5, formed in the vicinity of the central part of the cover 21 is an insertion hole 25 into which a part of the energization unit 90 (described later) is inserted. With this configuration, it is possible to fix the energization unit 90 to the cover 21. Possible materials of the cover 21 are not particularly limited. For example, the cover 21 may be produced by using metal such as aluminum or stainless steel, or may be produced by using non-metal such as a resin material.

The motor 40 comprises, as described above, the stator 41, the rotor 42, and the motor shaft 44 that rotates integrally with the rotor 42. The stator 41 and the rotor 42 are housed inside the left crank arm 6A. The motor shaft 44 is housed inside the left crank arm 6A and the crankshaft 30. With this configuration, it is possible to miniaturize the drive unit 20A, while keeping the motor 40 to a sufficient size.

The stator 41 is fixed to the inside of the left crank arm 6A by a press-fit, an adhesive agent, or a pin. In this situation, an elastic member such as a rubber member or urethane may be provided between the stator 41 and the left crank arm 6A. By providing the elastic member, it is possible to reduce vibration of the stator 41. Further, a heat dissipation sheet or a heat dissipation paste (heat dissipation grease, heat dissipation gel, or the like) may be provided between the stator 41 and the left crank arm 6A. With this configuration, it is possible to enhance heat dissipation capabilities of the motor 40 and to prevent overheating and vibration of the motor 40.

Preferably, the diameter of the stator 41 may be less than or equal to 100 mm. With this configuration, it is possible to easily have the motor 40 housed inside the left crank arm 6A and to thus miniaturize the drive unit 20A. Further, preferably, the diameter of the stator 41 may be greater than or equal to the diameter of the motor shaft 44. With this configuration, it is possible to stabilize the torque obtained from the motor shaft 44.

The rotor 42 is disposed inside the stator 41. Preferably, the rotor 42 may be fixed to the motor shaft 44 by using a serration. Alternatively, the rotor 42 may be fixed to the motor shaft 44, by a press-fit, a shrink-fit, a cooling-fit, or the like. Further, at the time of fixing the rotor 42 to the motor shaft 44, an elastic member such as a rubber member or urethane may be provided between the rotor 42 and the motor shaft 44.

While the rotation central axis thereof is coaxially positioned with the central axis 32 of the crankshaft 30, the motor shaft 44 penetrates a lock ring 33 in the direction along the central axis 32. In this situation, the lock ring 33 is provided for the purpose of preventing the left crank arm 6A from falling off the crankshaft 30. Because the central axis of the motor shaft 44 is positioned on the central axis 32 of the crankshaft 30, there is no need to provide a gear or the like for converting the rotation direction, at the time of transmitting the rotation force of the motor 40 to the motive power transmission mechanism 50 housed in the hollow part 31. With this configuration, it is possible to miniaturize the drive unit 20A.

The motor shaft 44 is supported to be rotatable on the central axis 32 by two bearings 23 provided in the lock ring 33. The bearings 23 do not necessarily need to be positioned inside the lock ring 33 and may be provided inside the crankshaft 30 or a crank arm 6, for example. Formed in an outer circumferential part of the section at the tip end of the motor shaft 44 protruding to the outside of the lock ring 33 is a teeth part engaging with planetary gears 513 (described later) of the first planetary gear mechanism 51.

Although the single motor 40 is provided in the first embodiment as shown in FIG. 3, two or more motors 40 may be provided. Providing two or more motors 40 makes it possible to yield a higher output. For example, one motor each may be provided inside the left crank arm 6A and inside the right crank arm 6B. Alternatively, the motor 40 may be provided inside the crankshaft 30. Also, when two or more motors 40 are provided, the motors may have mutually-different output characteristics.

The motor 40 does not necessarily need to be of an inner rotor type as shown in FIG. 3 and may be of an outer rotor type or an axial gap type. By using an axial gap type, it is possible to further flatten the crank arms 6.

Next, the rotor rotation detection substrate 105 used for reading the rotation of the motor 40 will be described. As shown in FIG. 3, the rotor rotation detection substrate 105 is positioned in the vicinity of the rotor 42 so as to overlap therewith in the rotation axis direction of the rotor 42, and is fixed to the left crank arm 6A by a screw or the like. The rotor rotation detection substrate 105 is provided with a Hall effect sensor. As a result of the Hall effect sensor detecting magnetic field changes caused by the rotation of the rotor 42, it is possible to measure the number of rotation of the rotor 42. The magnetic force detected by the Hall effect sensor may be magnetic force of another member that rotates together with the rotor 42.

A signal detected by the rotor rotation detection substrate 105 is output to the control device 100. For communication between the rotor rotation detection substrate 105 and the control device 100, a signal line may be used or wireless communication may be used. Further, the rotor rotation detection substrate 105 may be directly attached to the control substrate. The direct attachment makes it unnecessary to provide connectors and wirings for the connection, which makes it easier to miniaturize the drive unit 20A.

Further, the rotor rotation detection substrate 105 may be omitted, if there is no problem in controlling the rotation of the motor 40.

The crankshaft 30 penetrates the cover 21 in the direction along the central axis 32. The crankshaft 30 is supported to be rotatable on the central axis 32, by the bearings 22 provided at the two ends of the cover 21. The bearings 22 may be ball bearings, for example. In this situation, oil seal members may be provided between the crankshaft 30 and the bearings 22.

As shown in FIG. 3 and FIG. 4, the crankshaft 30 comprises the hollow part 31 on the inside thereof. The hollow part 31 houses therein a least a part of the motive power transmission mechanism 50. With this configuration, it is possible to miniaturize the drive unit 20A. The inside diameter and the outside diameter of the crankshaft 30 may be uniform or may vary over a range along the direction of the central axis 32. From the perspective of miniaturizing the drive unit 20A, the outside diameter of the crankshaft 30 may preferably be greater than or equal to 17 mm and less than or equal to 30 mm approximately. Further, the length of the crankshaft 30 in the direction along the central axis 32 may preferably be greater than or equal to 100 mm and less than or equal to 150 mm.

Next, the crankshaft rotation detection substrate 106 used for reading the rotation of the crankshaft 30 will be described. As shown in FIG. 3, the crankshaft rotation detection substrate 106 is provided inside the left crank arm 6A and fixed to the left crank arm 6A by a screw or the like. Further, the crankshaft rotation detection substrate 106 has installed therein a Hall effect sensor and is positioned so as to overlap, in the rotation axis direction, with a magnet 107 attached to the cover 21. As a result of the Hall effect sensor detecting magnetic field changes of the magnet 107 caused by the rotation of the crankshaft 30, it is possible to measure the number of rotation of the crankshaft 30.

Next, the motive power transmission mechanism 50 will be described. The motive power transmission mechanism 50 includes the first planetary gear mechanism 51, the one-way clutches 56, and the second planetary gear mechanism 52.

As shown in FIG. 3 and FIG. 5, the first planetary gear mechanism 51 comprises: a sun gear 511 being an external gear; an internal gear 512 positioned concentrically with the sun gear 511; four planetary gears 513; four planetary gear shafts 514; and a planetary carrier 515. As shown in FIG. 3, the hollow part 31 inside the crankshaft 30 houses therein a part of the sun gear 511, the internal gear 512, the planetary gears 513, the planetary gear shafts 514, and the planetary carrier 515 of the first planetary gear mechanism 51. In other words, at least a part of the motive power transmission mechanism 50 is housed in the hollow part 31. With this configuration, it is possible to miniaturize the drive unit 20A.

The sun gear 511 is the motor shaft 44 of the motor 40 and is an input shaft of the first planetary gear mechanism 51. The internal gear 512 is non-rotatably fixed to the crankshaft 30 by being fitted with an inner circumferential part of the crankshaft 30. The planetary gear shafts 514 rotatably hold the four planetary gears 513, respectively. The planetary carrier 515 supports the four planetary gear shafts 514 so as to be revolvable. With this configuration, the rotation force of the motor 40 is output to the planetary carrier 515 via the first planetary gear mechanism 51. In addition, the sun gear 511 serving as the input shaft and the rotation axis of the planetary carrier 515 serving as the output shaft are both positioned on the central axis 32 of the crankshaft 30. In other words, the rotation axes of the sun gear 511 and the planetary carrier 515 are positioned coaxially. With this configuration, it is possible to further miniaturize the motive power transmission mechanism 50.

As shown in FIG. 3 and FIG. 5, the two one-way clutches 56 are provided between the planetary carrier 515 and the sun gear 521 of the second planetary gear mechanism 52. With this configuration, the rotation force of the motor 40 output from the planetary carrier 515 is transmitted to the second planetary gear mechanism 52 via the one-way clutches 56. As a result of providing the one-way clutches 56, in the situation where the electric power storage device 10 driving the motor 40 has no remaining capacity, it is possible to prevent the rotor 42 and the like of the motor 40 from rotating, while the pedals 7 are being pedaled. In other words, if the one-way clutches 56 were not provided, because the rotor 42 and the like of the motor 40 would be rotated by the human driving force from the pedals 7 while the pedals 7 are being pedaled with no remaining capacity of the electric power storage device 10, drag resistance would be caused by cogging torque of the motor 40 or the like, and turning the pedals 7 would require large force. In contrast, because providing the one-way clutches 56 makes it more difficult for the rotor 42 of the motor 40 to rotate, it is possible to save the rider from applying extra force due to the cogging torque of the motor 40 or the like.

Preferably, the quantity of the one-way clutches 56 being provided may be two or more. With this configuration, it is possible to increase the torque that can be transmitted. Possibly, the quantity of the one-way clutches 56 being provided may be three or more. In addition, when a plurality of one-way clutches 56 are provided, the rotation axes of the one-way clutches 56 may preferably be the same as each other, i.e., be positioned coaxially. With this configuration, it is possible to miniaturize the drive unit 20A. Further, the one-way clutches 56 being used may preferably be clutches of a roller type, a sprag type, or a claw type.

As shown in FIG. 4 and FIG. 5, the second planetary gear mechanism 52 comprises: the sun gear 521 being an external gear; an internal gear 522 positioned concentrically with the sun gear 511; two stepped planetary gears 523; and two planetary gear shafts 524.

The sun gear 521 is an input shaft of the second planetary gear mechanism 52 and is supported to be rotatable on the central axis 32 by the two bearings 24 provided inside the crankshaft 30. For example, the bearings 24 may be ball bearings. The internal gear 522 is non-rotatably fixed to the cover 21, by being fitted with an inner circumferential part of the cover 21 via a serration. The planetary gear shafts 524 rotatably hold the two stepped planetary gears 523, respectively. Further, the two ends of the planetary gear shafts 524 are inserted into the output element 62. With this configuration, the rotation force of the motor 40 is output to the output element 62 via the second planetary gear mechanism 52. The quantity of the stepped planetary gears 523 may be one, or may be three or more.

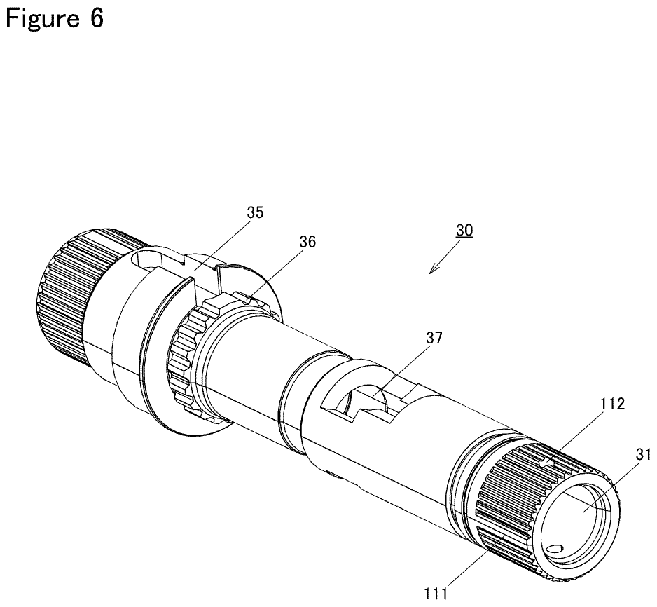

Next, details of the crankshaft 30, the human power transmitter 61, and the output element 62 will be described, with reference to FIGS. 6 to 8.

FIG. 6 is a perspective view of the crankshaft 30. The crankshaft 30 is a tubular member having the hollow part 31 inside. With the hollow part 31 penetrating the crankshaft 30 in the direction along the central axis 32, the two ends of the crankshaft 30 are open. However, possible shapes of the crankshaft 30 are not limited to the above example. For instance, the end of the crankshaft 30 may be closed on one side or on either side. Further, it is also acceptable to provide the hollow part 31 so as to be hollow in only a partial region of the crankshaft 30, while the other region is solid. Further, it is also acceptable to provide a plurality of hollow parts 31 separately inside the crankshaft 30.

In an outer circumferential part at the left end of the crankshaft 30, a serration is formed to which the left crank arm 6A is connected. Further, formed in an outer circumferential part of the crankshaft 30 on the left side is a crank groove 35 which has a recessed shape so that the energization member 101 (described later) passes therethrough. Formed on the right side of the crank groove 35 is a spline part 36 to be fitted with an inner circumferential part of the human power transmitter 61. Further, formed in a central part of the crankshaft 30 is a through hole 37 penetrated by a part of the second planetary gear mechanism 52. In addition, formed in an outer circumferential part at the right end of the crankshaft 30 are an insertion part 111 and a protrusion hole 112 used in a fixation method realized with the right crank arm 6B (described later).

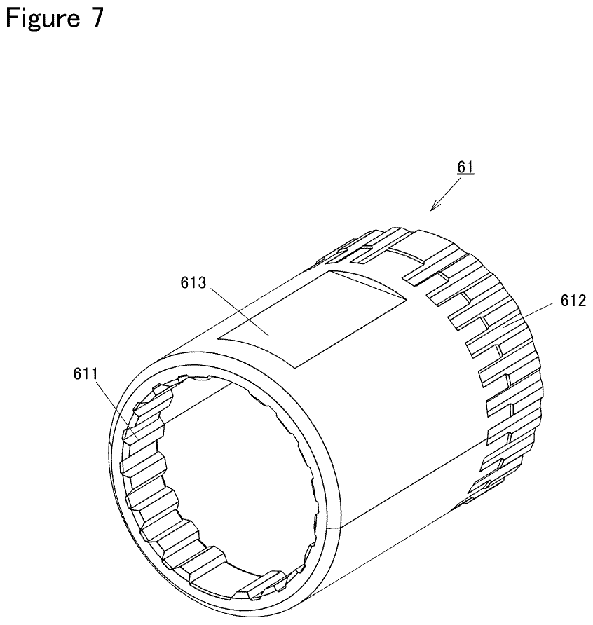

FIG. 7 is a perspective view of the human power transmitter 61. The human power transmitter 61 is a tubular member extending in the direction along the central axis 32 of the crankshaft 30 and is disposed in the cover 21 along the outer circumferential part of the crankshaft 30. The length of the human power transmitter 61 in the direction along the central axis 32 is not particularly limited, as long as it is possible to transmit the human driving force, but is, for example, greater than or equal to 20% and less than or equal to 50% of the length of the crankshaft 30 in the direction along the central axis 32.

Formed in an inner circumferential part at the left end of the human power transmitter 61 is a spline part 611 fitted with the spline part 36 (see FIG. 6) of the crankshaft 30. As a result, the human power transmitter 61 rotates integrally with the crankshaft 30. It is also acceptable to provide a missing tooth in the location where the human power transmitter 61 is fitted with the crankshaft 30. With this configuration, it is possible to determine the position in the direction of the installation and to easily carry out the assembly. Further, the human power transmitter 61 and the crankshaft 30 may be fitted with each other by a press-fit or by using a screw.

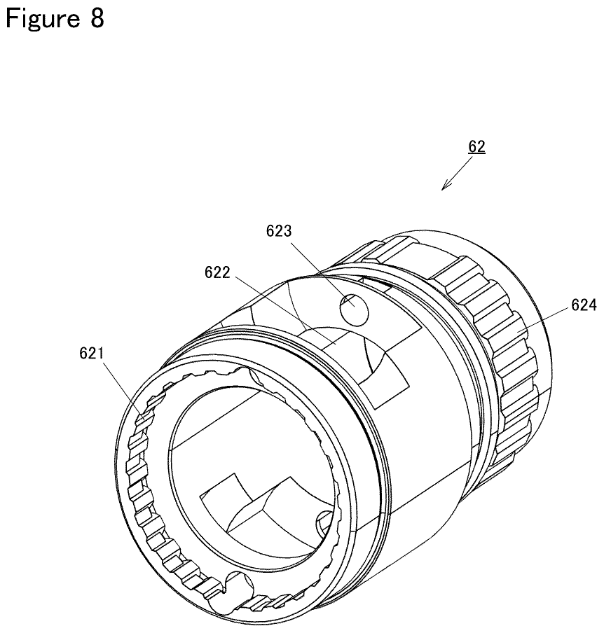

Formed in the outer circumferential part at the right end of the human power transmitter 61 is a spline part 612 fitted with a spline part 621 (see FIG. 8) provided in an inner circumferential part of the output element 62. Further, provided in an outer circumferential part of the human power transmitter are two human power transmitter grooves 613 in which the torque sensors 80 are placed. The two human power transmitter grooves 613 are provided at positions opposite to each other with respect to the circumferential direction of the outer circumferential part of the human power transmitter 61.

The output element 62 is a member that outputs the rotation force of the motor 40. In the present embodiment, the output element 62 is a tubular member extending in the direction along the central axis 32 of the crankshaft 30 and rotates together with the crankshaft 30. Alternatively, the output element 62 may be rotatable relative to the crankshaft 30. The length of the output element 62 in the direction along the central axis 32 is not particularly limited, as long as it is possible to transmit the human driving force and the rotation force of the motor 40, but is, for example, greater than or equal to 20% and less than or equal to 50% of the length of the crankshaft 30 in the direction along the central axis 32.

FIG. 8 is a perspective view of the output element 62. Formed in the inner circumferential part at the left end of the output element 62 is the spline part 621 fitted with the spline part 612 (see FIG. 7) of the human power transmitter 61. With this configuration, the human power transmitter 61 and the output element 62 rotate integrally. Further, it is also acceptable to provide a missing tooth in the location where the human power transmitter 61 is fitted with the output element 62. With this configuration, it is possible to determine the position in the direction of the installation and to easily carry out the assembly. Further, although the outer circumferential part of the human power transmitter 61 is fitted with the inner circumferential part of the output element 62 in the present embodiment, an inner circumferential part of the human power transmitter 61 may be fitted with an outer circumferential part of the output element 62. Further, the output element 62 and the crankshaft 30 may be formed integrally.

Formed in a central part of the output element 62 is a through hole 622 penetrated by the planetary gears 523 of the second planetary gear mechanism 52. Further, formed in the side wall of the through hole 622 are insertion holes 623 into which the planetary gear shafts 524 of the second planetary gear mechanism 52 are inserted. In other words, the planetary gear shafts 524 of the second planetary gear mechanism 52 and the output element 62 rotate integrally. With this configuration, the rotation force of the motor 40 input to the second planetary gear mechanism 52 is output to the output element 62.

The right side of the output element 62 protrudes to the outside of the cover 21. Further, formed in an outer circumferential part of the protruding section is the spline part 624 to which the front sprocket 70 is fixed. As a result, the front sprocket 70 rotates integrally with the output element 62.

Although being separately provided in the first embodiment, the human power transmitter 61 and the output element 62 may be formed integrally. For example, it is also acceptable to provide only the output element 62, without providing the human power transmitter 61. In that situation, it is possible to cause the electric assist bicycle 1 to move forward by transmitting the rotation force of the crankshaft 30 realized by the human driving force to the output element 62.

Further, a one-way clutch may be disposed between the human power transmitter 61 and the output element 62. The one-way clutch is configured, while the human power transmitter 61 is rotating in the forward direction, to transmit the rotation force thereof to the output element 62 and is configured, while the human power transmitter 61 is rotating in the backward direction, not to transmit the rotation force thereof to the output element 62. Also, the one-way clutch is configured, while the output element 62 is rotating in the forward direction, not to transmit the rotation force thereof to the human power transmitter 61.

Further, a one-way clutch may be disposed between the output element 62 and the front sprocket 70. The one-way clutch is configured, while the output element 62 is rotating in the forward direction, to transmit the rotation force thereof to the front sprocket 70 and is configured, while the output element 62 is rotating in the backward direction, not to transmit the rotation force thereof to the front sprocket 70. By providing the one-way clutch, it is possible to reduce component parts that would follow around when the crank arms 6 are rotated in the backward direction and to thus reduce a weight to be felt by the rider.

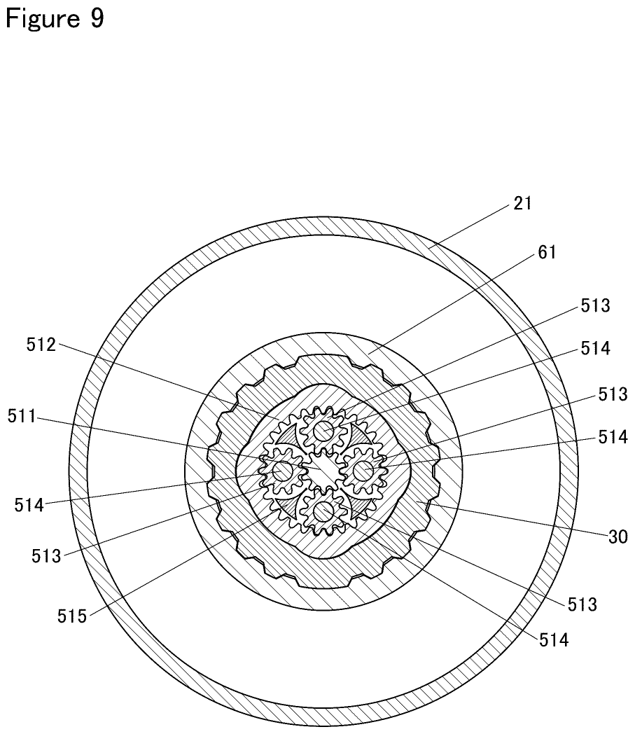

Next, details of the first planetary gear mechanism 51 and the second planetary gear mechanism 52 constituting the motive power transmission mechanism 50 will be described, with reference to FIGS. 9 to 11.

FIG. 9 is a sectional view taken at line A-A in FIG. 3 and is a sectional view of the first planetary gear mechanism 51. As shown in FIG. 9, the first planetary gear mechanism 51 comprises: the sun gear 511 being an external gear; the internal gear 512 positioned concentrically with the sun gear 511; the four planetary gears 513; the four planetary gear shafts 514; and the planetary carrier 515. By being fitted with the inner circumferential part of the crankshaft 30, the internal gear 512 is non-rotatably fixed to the crankshaft 30. The planetary gears 513 engage with external teeth of the sun gear 511 and with internal teeth of the internal gear 512.

Possible structures of the first planetary gear mechanism 51 are not limited to the mechanism described above. For example, the planetary carrier 515 may be non-rotatably fixed to the crankshaft 30, by having the planetary carrier 515 fitted with the crankshaft 30. In that situation, the rotation force of the motor 40 input to the sun gear 511 is output to the internal gear 512 via the first planetary gear mechanism 51. Further, for example, the sun gear 511 may be non-rotatably fixed to the crankshaft 30, by having the sun gear 511 fitted with the crankshaft 30. In that situation, as a result of the internal gear 512 being used as an input shaft of the first planetary gear mechanism 51, the rotation force of the motor 40 is output to the planetary carrier 515 via the first planetary gear mechanism 51.

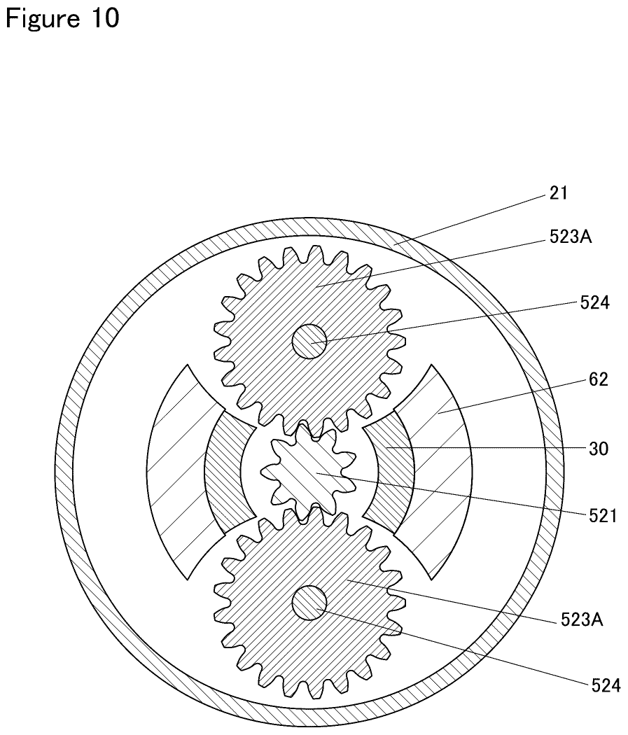

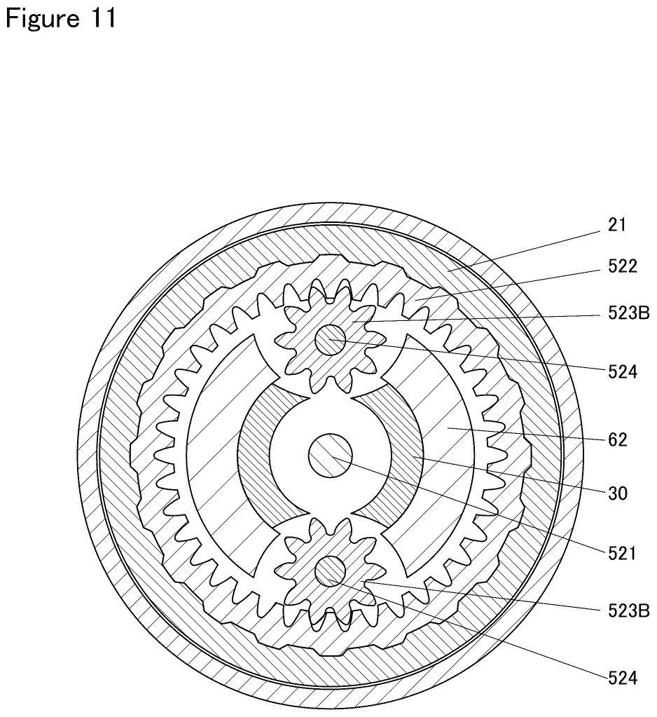

FIG. 10 is a sectional view taken at line B-B in FIG. 4 and is a sectional view of the first step of the second planetary gear mechanism 52. FIG. 11 is a sectional view taken at line C-C in FIG. 4 and is a sectional view of the second step of the second planetary gear mechanism 52. As shown in FIG. 10 and FIG. 11, the second planetary gear mechanism 52 comprises: the sun gear 521 being an external gear; the internal gear 522 positioned concentrically with the sun gear 511; the two stepped planetary gears 523; and the two planetary gear shafts 524. Further, each of the stepped planetary gears 523 includes a first planetary gear 523A, and a second planetary gear 523B having a smaller diameter than that of the first planetary gear 523A.

As shown in FIG. 10, the first planetary gears 523A engage with external teeth of the sun gear 521. Further, the first planetary gears 523A are disposed so as to penetrate the through hole 37 (see FIG. 6) of the crankshaft 30 and the through hole 622 (see FIG. 8) of the output element 62. Also, the first planetary gears 523 A are housed inside the cover 21.

As shown in FIG. 11, by being fitted with an inner circumferential part of the cover 21, the internal gear 522 is non-rotatably fixed to the cover 21. The second planetary gears 523B engage with internal teeth of the internal gear 522. Further, similarly to the first planetary gears 523A, the second planetary gears 523B are disposed so as to penetrate the through hole 37 (see FIG. 6) of the crankshaft 30 and the through hole 622 (see FIG. 8) of the output element 62. By using the stepped planetary gears 523 as shown in FIG. 10 and FIG. 11, it is possible to increase a reduction ratio of the second planetary gear mechanism 52.

A metal gear or a resin gear may be used as each of the gears in the first planetary gear mechanism 51 and the second planetary gear mechanism 52. By using resin gears, it is possible to make the drive unit 20A lightweight and to further mitigate noise during rides. Examples of resin materials that can be used include polyacetal, 46-nylon, 66-nylon, PEEK, and thermosetting resin. Also, super engineering plastic may be used.

Further, of the stepped planetary gears 523, mutually-different materials may be used for the first planetary gears 523A and for the second planetary gears 523B. By using the mutually-different materials, it is possible to easily provide each of the one-way clutches 56 between the first planetary gear 523A and the second planetary gear 523B.

The gears of the first planetary gear mechanism 51 and the second planetary gear mechanism 52 may preferably be lubricated with grease, but may be lubricated with lubricant oil. By using lubricant oil, it is possible to reduce abrasion on teeth surfaces of the gears.

In the first embodiment, the two planetary gear mechanisms, namely, the first planetary gear mechanism 51 and the second planetary gear mechanism 52 are used. However, it is also acceptable to use only one planetary gear mechanism or to use three or more planetary gear mechanisms. It is possible to transmit high torque by using a plurality of planetary gears in each of the planetary gear mechanisms, because the motive power transmission paths are distributed. Further, by using three or more planetary gears, it is possible to reduce teeth widths of the gears and to further miniaturize the drive unit.

Further, as each of the planetary gear mechanisms, a Ravigneaux planetary gear mechanism, a mechanical paradox planetary gear mechanism, or a wave gear device may be used. Further, as each of the gears in the planetary gear mechanisms, a helical gear may be used, instead of a spur gear. It is also acceptable to use both one or more helical gears and one or more spur gears. Further, the motive power transmission mechanism 50 may include, in addition to the planetary gear mechanisms, a bevel gear, a hypoid gear, or gears having parallel shafts.

The reduction ratio of the motive power transmission mechanism 50 may preferably be greater than or equal to 3 and less than or equal to 60. The torque of the motor 40 transmitted to the output element 62 may preferably be greater than or equal to 5 Nm and less than or equal to 100 Nm approximately. Further, a maximum number of rotation of the output element 62 realized by the driving force of the motor 40 may preferably be greater than or equal to 40 rpm and less than or equal to 150 rpm approximately, which is suitable for human cadence.

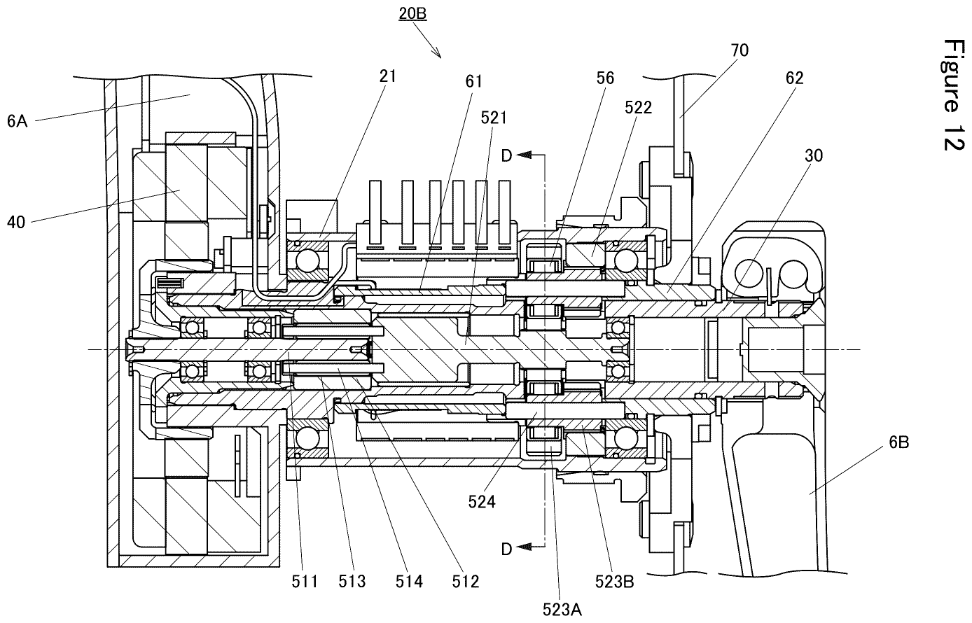

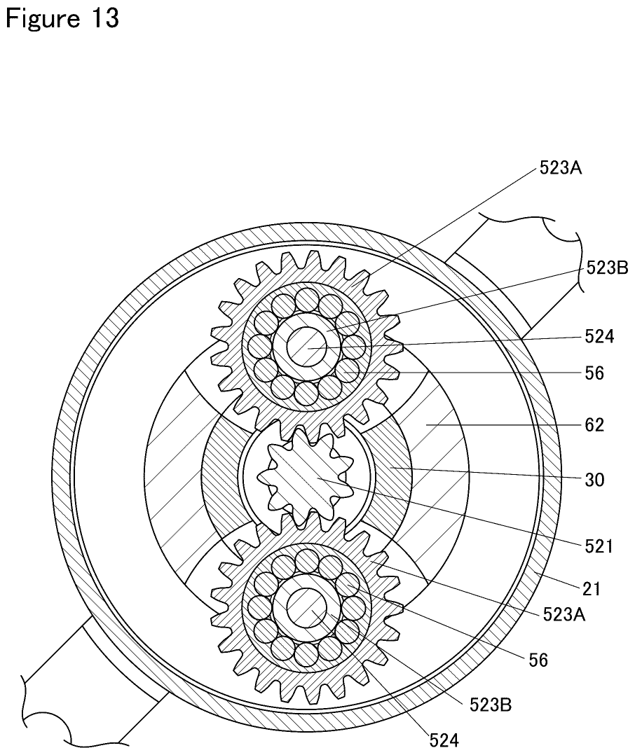

FIG. 12 is a sectional view of a drive unit 20B according to a modification example of the first embodiment. FIG. 13 is a sectional view taken at line D-D in FIG. 12 and is a sectional view of the first step of the second planetary gear mechanism 52. The drive unit 20B shown in FIG. 12 is different from the drive unit 20A (see FIG. 2 and so on) described above for a configuration of the second planetary gear mechanism 52. More specifically, the second planetary gear mechanism 52 in the drive unit 20B is configured so that the second planetary gears 523B of the stepped planetary gears 523 transversally penetrate the first planetary gear 523A. In addition, each of the one-way clutches 56 is provided between the inner circumferential part of the first planetary gear 523A and the outer circumferential part of the second planetary gear 523B. With this configuration, the rotation force of the first planetary gears 523A is transmitted to the second planetary gears 523B via the one-way clutches 56. By providing the second planetary gear mechanism 52 with the one-way clutches 56, in the situation where the electric power storage device 10 driving the motor 40 has no remaining capacity, it is possible to further reduce the drag resistance, compared to the situation where the one-way clutches 56 are provided between the first planetary gear mechanism 51 and the second planetary gear mechanism 52 (see FIG. 2). With this configuration, it is possible to further save the rider from applying extra force due to the cogging torque of the motor 40 or the like.

In the first embodiment, the electric assist bicycle 1 is described in which, as shown in FIG. 2 and FIG. 12, the crank arms 6 are provided at the two ends of the crankshaft 30. However, the present disclosure is also applicable to an electric vehicle that does not have the crank arms 6 provided at the two ends of the crankshaft 30. Even for an electric vehicle that does not have the crank arms 6 provided, it is possible to miniaturize the drive unit 20, by configuring at least a part of the motive power transmission mechanism 50 to be housed in the hollow part 31 provided inside the crankshaft 30.

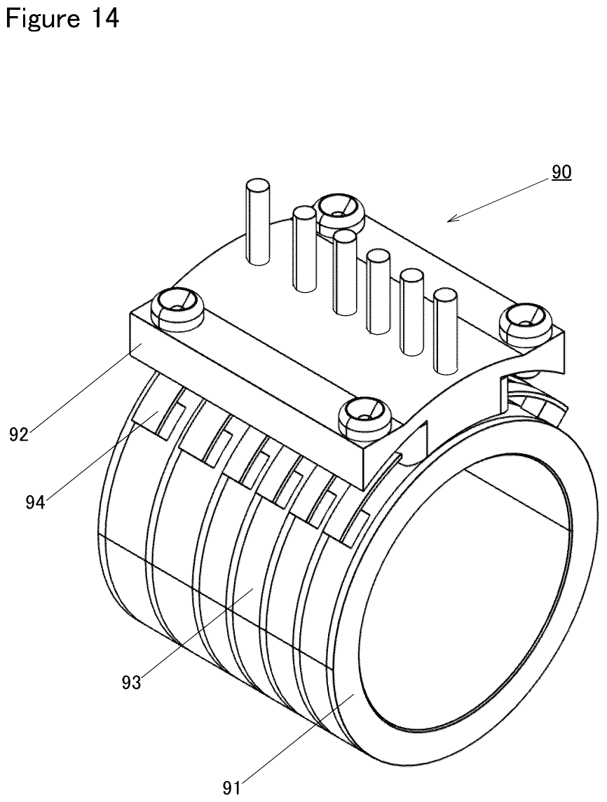

Next, an electric power supply method of the drive unit 20A will be described with reference to FIG. 14. FIG. 14 is a perspective view of the energization unit 90. The energization unit 90 supplies the electric power from the electric power storage device 10 (see FIG. 1) housed in the frame 2, to devices such as the motor 40 housed in the crankshaft 30 and the crank arm 6. A slip ring mechanism is used in the energization unit 90. With this configuration, even while the crankshaft 30 and the crank arms 6 are rotating, it is possible to supply the electric power from the electric power storage device 10 housed in the frame 2, to devices such as the motor 40 housed in the crank arm 6.

The energization unit 90 comprises: a rotation part 91 having a function of an electric power reception part; and a brush unit 92 having a function of an electric power supply part that supplies electric power to the rotation part 91. As shown in FIG. 14, the rotation part 91 is a tubular member which extends in the direction along the central axis 32 of the crankshaft 30 and through which the crankshaft 30 is inserted. The rotation part 91 rotates in conjunction with the rotation of the crankshaft 30. The rotation part 91 includes a slip ring 93 over the entire circumference of an outer circumferential part thereof. In other words, the slip ring 93 is penetrated by the crankshaft 30. Alternatively, it is also acceptable to provide the slip ring 93 in an outer circumferential part of the crankshaft 30 or the human power transmitter 61, without providing the rotation part 91.

The brush unit 92 is fixed to the cover 21 by being inserted in the insertion hole 25 (see FIG. 5) provided in the vicinity of a central part of the cover 21 and is connected to the electric power storage device 10. In other words, the brush unit 92 rotates relative to the rotation part 91. The brush unit 92 comprises a brush 94 that abuts against the slip ring 93. For example, the brush 94 is formed by using a member of which a main component is graphite, which is electrically conductive. The brush 94 is configured so that as the slip ring 93 rotates, a tip end part of the brush 94 slides while in an abutting state, so that electric power is supplied from the brush 94 to the slip ring 93. In other words, as a result of the rotation part 91 and the brush unit 92 implementing a contact electric power supply scheme, the electric power is supplied from the brush unit 92 to the rotation part 91. In the energization unit 90, an electric current supplied from the electric power storage device 10 may preferably be less than or equal to 50 A.

Other than the method using the slip ring mechanism, a contactless electric power supply scheme may be applied to the energization unit 90. When a contactless electric power supply scheme is used, the energization unit 90 comprises a rotation part and an electric power supply part. The rotation part is a tubular member that extends in the direction along the central axis 32 of the crankshaft 30 and is penetrated by the crankshaft 30. The rotation part rotates in conjunction with the rotation of the crankshaft 30. The rotation part comprises an electric power reception part over the entire circumference of an outer circumferential part thereof. In other words, the electric power reception part is penetrated by the crankshaft 30. The electric power reception part has an electric power reception coil. The electric power reception coil may be a wireless power transfer coil obtained by winding an electrically conductive wire, for example. Alternatively, the electric power reception part may be provided in an outer circumferential part of the crankshaft 30 or the human power transmitter 61, without providing the rotation part.

The electric power supply part comprises an electric power transmission part that contactlessly transmits electric power to the electric power reception part, while the electric power transmission part has a power transmission coil. The power transmission coil is a wireless power transfer coil obtained by winding an electrically conductive wire, for example. By using the wireless electric power supply scheme, it is possible to supply the electric power to the motor 40 and the like, even while the crankshaft 30 and the crank arms 6 are rotating.

The electric power supplied to the slip ring 93 of the energization unit 90 is supplied to the control device 100 and a motor terminal 108, or the like, via the energization member 101 (FIG. 3). The energization member 101 is a cord, for example. The energization member 101 extending from the slip ring 93 passes through the crank groove 35 (see FIG. 6) having the recessed shape and being formed in a part of the outer circumferential part of the crankshaft 30, and is electrically connected to the motor 40. By having the energization member 101 pass through the crank groove 35, it is possible to supply the electric power from the energization unit 90 to the motor 40 and the like, without the need to increase the diameter of the drive unit 20A. Further, it is also acceptable to provide a removable cover for the rotor 42 of the motor 40 so that the energization member 101 does not come into contact with the motor 40. It is also acceptable to fix the energization member 101 to a crank arm 6, by using a clip or the like.

Next, a heat dissipation mechanism inside a crank arm 6 and a method for fixing a crank arm 6 and the crankshaft 30 together will be described.

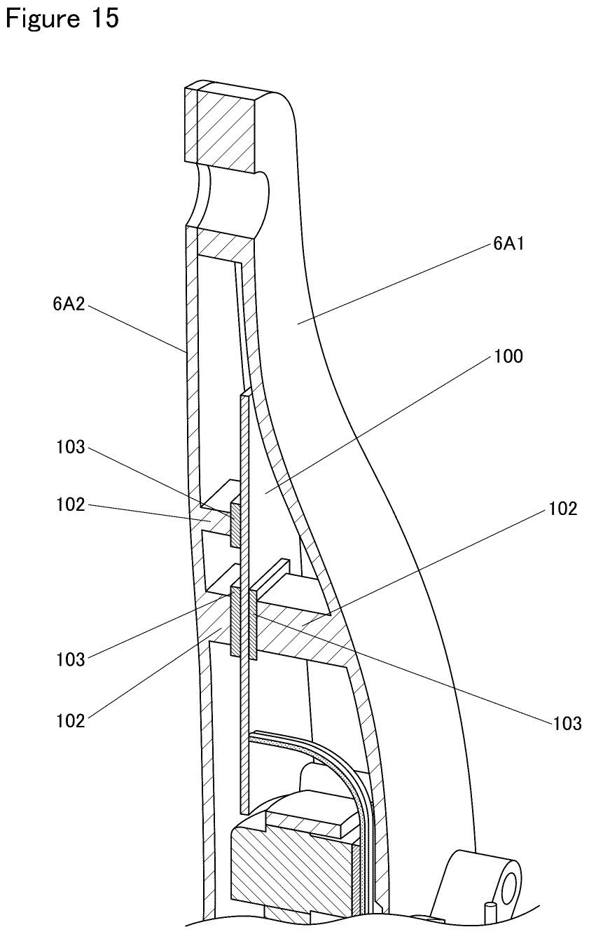

First, the heat dissipation mechanism inside the crank arm will be described. As described above, the control substrate having installed therein the control device 100 to control the rotation force of the motor 40, is housed in the left crank arm 6A. Because the control substrate generates heat while the electric assist bicycle 1 is ridden, the control substrate may preferably be provided with the heat dissipation mechanism. FIG. 15 is a perspective view of the inside of the left crank arm 6A of the drive unit 20A. Formed inside the left crank arm 6A are a plurality of heat dissipation parts 102 originating from an inner part 6A1 positioned on the inside of the left crank arm 6A and an outer part 6A2 positioned on the outside of the left crank arm 6A, so as to extend toward the control substrate. With this configuration, the heat generated by the control substrate is dissipated to the outside via the heat dissipation parts 102. Heat conductors 103 are provided between the control substrate and the heat dissipation parts 102. With this configuration, it is possible to further enhance heat dissipation capabilities of the control substrate.

As shown in FIG. 15, the heat dissipation parts 102 may preferably be provided on both surfaces of the control substrate, but may be provided only on one of the surfaces. Further, when the heat dissipation parts 102 are provided on both surfaces of the control substrate, from the perspective of enhancing the heat dissipation capabilities, the heat dissipation parts 102 on the two surfaces may preferably be provided so as to overlap with each other while the control substrate is interposed therebetween. Further, from the perspective of enhancing the heat dissipation capabilities, preferably two or more heat dissipation parts 102 may be provided, and even more preferably, three or more heat dissipation parts 102 may be provided.

As long as the heat dissipation capabilities thereof are high, the heat dissipation parts 102 and the heat conductors 103 are not particularly limited, and it is acceptable to use metal such as an aluminum alloy, copper, or iron, for example. Further, to further enhance the heat dissipation capabilities, a plurality of ribs may preferably be provided on a surface and a side wall of the heat dissipation parts 102.

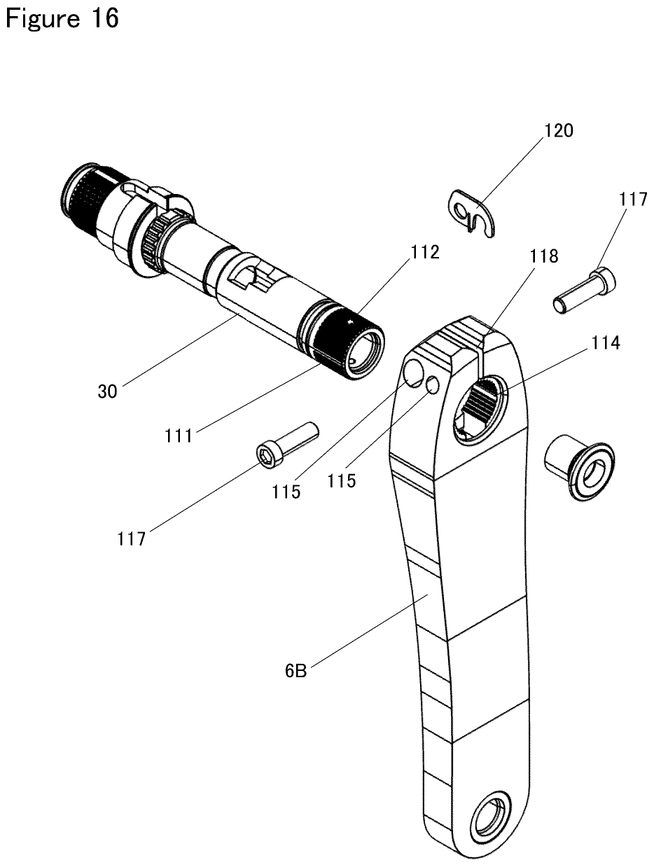

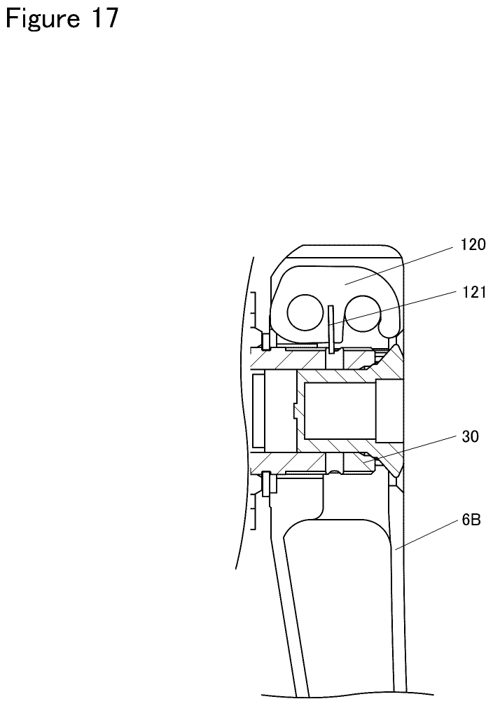

Next, a method for fixing the crankshaft 30 and the right crank arm 6B together will be described, with reference to FIGS. 16 and 17. FIG. 16 is an exploded perspective view of the crankshaft 30 and the crank arm 6. As shown in FIG. 16, the crankshaft 30 comprises, at the right end thereof, the insertion part 111 to be inserted into the right crank arm 6B. Formed in an outer circumferential part of the insertion part 111 is a serration (described later) that can be press-fitted into an insertion hole 114 of the right crank arm 6B. Although not particularly limited, the length of the insertion part 111 in the direction along the central axis 32 may be greater than or equal to 5 mm and less than or equal to 50 mm, for example, from the perspective of stably fixing the right crank arm 6B. Further, formed in an outer circumferential surface of the insertion part 111 is a protrusion hole 112 into which a protrusion part 121 of a fixation component part 120 (described later) is inserted.

The right crank arm 6B comprises the insertion hole 114, fixation holes 115, and a cutout 118. Further, the right crank arm 6B comprises the fixation component part 120 in an attachable/detachable manner. The insertion hole 114 is a hole which extends in the direction along the central axis 32 of the crankshaft 30 so as to penetrate the right crank arm 6B, and into which the insertion part 111 of the crankshaft 30 is inserted. Formed in an inner circumferential part of the insertion hole 114 is a serration corresponding to the serration of the insertion part 111. In this situation, when the insertion part 111 has been inserted in the insertion hole 114, the insertion part 111 and the insertion hole 114 may preferably have a relationship of a clearance fit. Having the clearance fit relationship makes it easier to attach and detach the right crank arm 6B and the crankshaft 30 to and from each other. It is also acceptable to provide a missing tooth in the location where the insertion part 111 is fitted in the insertion hole 114 so as to determine the position in the direction of the installation. With this configuration, it is possible to easily attach the crankshaft 30 and the crank arm 6 to each other.

The fixation holes 115 are each a hole through which a bolt 117 for a fastening purpose is inserted, at the time of inserting and fixing the insertion part 111 into the insertion hole 114. The fixation holes 115 extend along the direction orthogonal to the extending direction of the insertion hole 114 and orthogonal to the longitudinal direction of the right crank arm 6B, so as to penetrate the right crank arm 6B. With respect to the longitudinal direction of the right crank arm 6B, the fixation holes 115 are formed between the end on the side (hereinafter, “crankshaft side”) opposite to the side on which the right crank arm 6B and the pedals 7 are attached, and the insertion hole 114. Although the two fixation holes 115 are provided in the drive unit 20A, the quantity thereof may be one, or may be three or more.

The cutout 118 is a cutout formed originating from the end of the right crank arm 6B on the crankshaft side toward the insertion hole 114. While the insertion part 111 is inserted in the insertion hole 114, when the bolts 117 are inserted into the fixation holes 115 and tightened, the cutout 118 becomes deflected, so that the crankshaft 30 and the right crank arm 6B are fixed together. The bolts 117 may be made of metal or may be made of resin.

FIG. 17 is an enlarged sectional view of the fixation component part 120. As shown in FIG. 17, the fixation component part 120 has formed therein the holes to be penetrated by the bolts 117. Further, the fixation component part 120 has the protrusion part 121 extending downward. When the insertion part 111 of the crankshaft 30 has been inserted in the insertion hole 114 of the right crank arm 6B, the protrusion part 121 is inserted into the protrusion hole 112 (see FIG. 16). With this configuration, even when the crank arm 6 powerfully rotates on the crankshaft 30, it is possible to prevent the crank arm 6 from coming off the crankshaft 30 and to easily attach the crankshaft 30 and the crank arm 6 together.

Next, a method for fixing the left crank arm 6A and the crankshaft 30 together while the motor 40 is housed therein will be described. The left crank arm 6A and the crankshaft 30 may preferably be engaged with each other by a serration. Even more preferably, at least parts thereof may be fixed together by a press-fit. By fixing at least parts thereof with the press-fit, it is possible to prevent the left crank arm 6A from coming off the crankshaft 30. Further, even more preferably, the lock ring 33 may be used (see FIG. 3) for the purpose of preventing the left crank arm 6A from coming off.

The lock ring 33 may preferably have flower-petal notches on the side wall thereof (see FIG. 5). With this configuration, it is possible to enhance an effect of preventing the lock ring 33 from loosening. Further, from the perspective of preventing the lock ring 33 from coming off, the lock ring 33 may preferably be fixed to the left crank arm 6A, by using a setscrew. Further, from the perspective of further preventing the lock ring 33 from coming off, an adhesive agent for preventing loosening may preferably be applied to a screw used for fixing the lock ring 33 to the left crank arm 6A.

### Second Embodiment

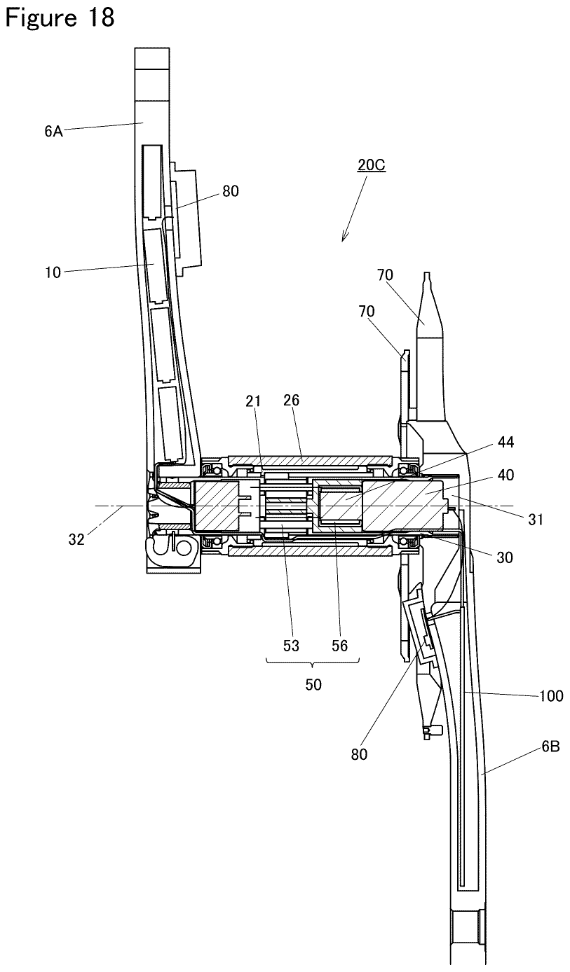

Next, a drive unit 20C according to the second embodiment will be described, with reference to FIGS. 18 to 20. In the following sections, differences from the first embodiment will primarily be described, while some of the constituent elements that are the same or similar will be referred to by using the same reference signs.

FIG. 18 is a sectional view of the entirety of the drive unit 20C according to the second embodiment. FIG. 19 is an enlarged view of the vicinity of the crankshaft 30 of the drive unit 20C. As shown in FIG. 18, the drive unit 20C comprises: the motor 40 that gives the rotation force to provide assistance for the pedaling force from the pedals 7; the housing including the cover 21 and a bottom bracket 26; and the crankshaft 30 rotatably attached to the housing. The drive unit 20C further comprises the motive power transmission mechanism 50 that transmits the rotation force of the motor 40 to the crankshaft 30.

The crankshaft 30 is a tubular member that penetrates the cover 21 in the direction along the central axis 32 and has the hollow part 31 on the inside thereof. The crankshaft 30 is supported by the bearings 22 so as to be rotatable on the central axis 32. The hollow part 31 houses therein at least a part of the motive power transmission mechanism 50. While comprising the motive power transmission mechanism 50, this configuration makes it possible to miniaturize the drive unit 20C. In other words, it is possible to realize the drive unit 20C that is miniaturized, while guaranteeing capabilities related to a reduction ratio and the like that are required when the electric assist bicycle 1 is ridden.

The motor 40 is housed in the hollow part 31. With this configuration, it is possible to miniaturize the drive unit 20C. Further, the central axis of the rotation of the motor shaft 44 is positioned coaxially with the central axis 32 of the crankshaft 30. With this configuration, at the time of transmitting the rotation force of the motor 40 to the motive power transmission mechanism 50 housed inside the crankshaft 30, there is no need to provide a gear or the like for converting the rotation direction, and it is therefore possible to further miniaturize the drive unit 20C.

The drive unit 20C further comprises the pair of crank arms 6, to each of which a different one of the pedals 7 is attached. The pair of crank arms 6 are connected to the two ends of the crankshaft 30. The crankshaft 30 is rotated by the human driving force applied to the pedals 7.

The drive unit 20C further comprises the front sprocket 70. The front sprocket 70 is fixed to the right crank arm 6B. As a result, the front sprocket 70 rotates integrally with the right crank arm 6B and the crankshaft 30. Further, the front sprocket 70 and the rear wheel sprocket 11 (see FIG. 1) are connected together via the chain 8 (see FIG. 1).

An overview of a motive power transmission path of the drive unit 20C can be described as follows. First, a motive power transmission path for the human driving force applied to the pedals 7 will be described. As a result of a rider pedaling on the pedals 7 of the electric assist bicycle 1, the crank arms 6, the crankshaft 30, and the front sprocket 70 integrally rotate in the forward direction. Further, when the front sprocket 70 rotates in the forward direction, rotation force from the rotation in the forward direction is applied to the rear wheel sprocket 11 via the chain 8, and the rear wheel sprocket 11 and the rear wheel 3B thus rotate in the forward direction. As a result, the electric assist bicycle 1 moves forward. A difference from the drive unit 20A in the first embodiment lies in that, although in the drive unit 20A in the first embodiment the front sprocket 70 rotates as a result of the human driving force being transmitted to the front sprocket 70 via the human power transmitter 61 and the output element 62, in the drive unit 20C in the second embodiment, the front sprocket 70 rotates integrally with the right crank arm 6B.

Next, a motive power transmission path for the rotation force of the motor 40 will be described. When the motor shaft 44 of the motor 40 rotates in the forward direction, the rotation force thereof is transmitted to the crankshaft 30 via the motive power transmission mechanism 50 including a planetary gear mechanism 53, and the crankshaft 30 thus rotates in the forward direction. When the crankshaft 30 rotates in the forward direction, the crank arms 6 and the front sprocket 70 rotate integrally with the crankshaft 30 in the forward direction. As a result, the electric assist bicycle 1 moves forward. A difference from the drive unit 20A in the first embodiment can be described as follows: Firstly, in the drive unit 20A in the first embodiment, the front sprocket 70 rotates, as a result of the rotation force of the motor 40 being transmitted to the front sprocket 70 via the output element 62 that rotates together with the crankshaft 30. In contrast, in the drive unit 20C in the second embodiment, the rotation force of the motor 40 is transmitted to the crankshaft 30, so that the front sprocket 70 rotates together with the crankshaft 30. In other words, the crankshaft 30 has a function of an output element for the drive unit 20C.

The drive unit 20A further comprises: one or more torque sensors 80 that detect torque of the human driving force; and the control device 100 for realizing an appropriate electric assist function, by controlling outputs of the motor 40 in accordance with the detected torque.

As shown in FIG. 18, each of the torque sensors 80 is provided on the inside face of a corresponding one of the left crank arm 6A and the right crank arm 6B. Similarly to the drive unit 20A, as each of the torque sensors 80, for example, a strain sensor that detects physical strain or a strain sensor that detects magnetic changes may be used. Further, for example, it is also acceptable to use a scheme by which paint that emits light in response to a mechanical stimulation is applied to an outer circumferential part of the human power transmitter 61, so that an optical sensor detects the light.

A torque sensor 80 may be provided for only one of the crank arms 6. One or more torque sensors 80 may be provided in the outer circumferential part of the crankshaft 30. Further, one or more torque sensors 80 may be provided for the spider arm 71. Further, it is also acceptable to provide each of the left and the right crank arms 6 with the torque sensor 80, while the motor 40 is provided in a wheel 3. Further, it is also acceptable to provide one of the crank arms 6 and an outer circumferential part of the crankshaft 30 each with a torque sensor 80, while the motor 40 is provided in the wheel 3. Signals detected by the torque sensors 80 are output to the control device 100 installed in the control substrate housed in the right crank arm 6B. The control device 100 may obtain torque applied to each of the crank arms 6, by performing calculations based on the signals from the torque sensors 80.

Next, the electric power storage device 10 will be described. As shown in FIG. 18, the electric power storage device 10 is housed inside the left crank arm 6A. By having the electric power storage device 10 housed inside the crank arm 6, it is possible to provide the electric assist bicycle 1 with the electric power storage device 10, without ruining the external appearance of the electric assist bicycle 1. Further, by having the electric power storage device 10 housed in the crank arm 6, it is possible to supply the electric power to the motor 40 and the like without providing the energization unit 90 (see FIG. 2, and so on), even when the motor 40 and the like are provided in the hollow part 31 of the crankshaft 30. Voltage of the electric power storage device 10 housed in the crank arm 6 may be lower than voltage of the electric power storage device 10 housed in the frame 2, as described in the first embodiment.

Further, the electric power storage device 10 may be housed not only inside the crank arm 6, but also inside a pedal 7. By having the electric power storage device 10 housed inside the pedal 7 also, it is possible to realize an increased capacity of the electric power storage devices 10.

The left crank arm 6A housing the electric power storage device 10 therein may preferably be fixed to the crankshaft 30, by using the fixation method shown in FIG. 16. With this configuration, it is possible to easily attach and detach the left crank arm 6A at the time of charging the electric power storage device 10 and to thus easily carry out the charging process indoor.

Next, the motive power transmission mechanism 50 of the drive unit 20C will be described, with reference to FIG. 19. The motive power transmission mechanism 50 includes the planetary gear mechanism 53 and the one-way clutch 56.

As shown in FIG. 19, the one-way clutch 56 is provided between the motor shaft 44 of the motor 40 and a sun gear 531 of the planetary gear mechanism 53. With this configuration, the rotation force of the motor 40 is transmitted from the motor shaft 44 to the planetary gear mechanism 53 via the one-way clutch 56. In another example, a plurality of one-way clutches 56 and a plurality of planetary gear mechanisms 53 may be provided.

The planetary gear mechanism 53 comprises: the sun gear 531 being an external gear; an internal gear 532 positioned concentrically with the sun gear 531; four planetary gears 533; and four planetary gear shafts 534. As shown in FIG. 19, the hollow part 31 inside the crankshaft 30 houses therein the sun gear 531 and a part of the planetary gears 533 of the planetary gear mechanism 53. In other words, at least a part of the motive power transmission mechanism 50 is housed in the hollow part 31. With this configuration, it is possible to miniaturize the drive unit 20C. The quantity of the planetary gears 533 may be one, or may be two or more.

The sun gear 531 is an input shaft of the planetary gear mechanism 53. The internal gear 532 is non-rotatably fixed to the cover 21, by being fitted with an inner circumferential part of the cover 21. The planetary gears 533 engage with the sun gear 531 and also engage with the internal gear 532. The planetary gear shafts 534 rotatably hold the four planetary gears 513, respectively. Further, the two ends of the planetary gear shafts 534 are inserted in the crankshaft 30. With this configuration, the rotation force of the motor 40 is output to the crankshaft 30 via the planetary gear mechanism 53, and the crankshaft 30 thus rotates.

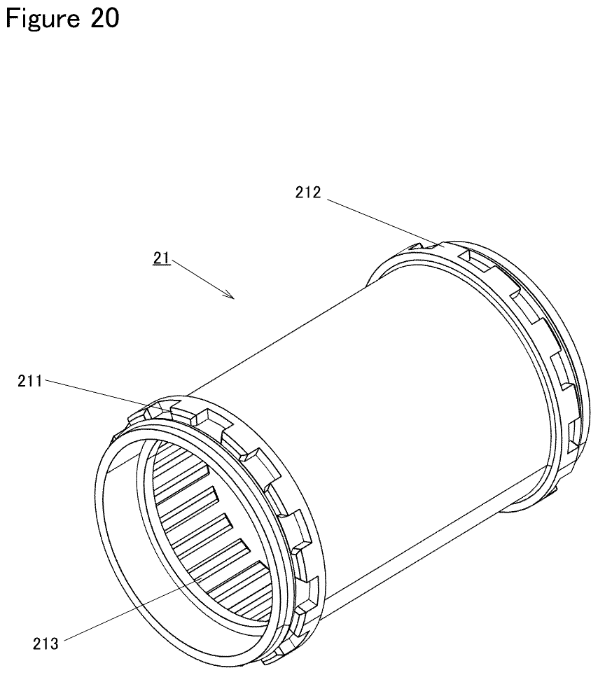

Next, a housing of the drive unit 20C will be described with reference to FIG. 19 and FIG. 20.

The housing includes the cover 21, the bottom bracket 26, and a screw member that fixes the cover 21 and the bottom bracket 26 together. The cover 21 is a tubular member that extends in the direction along the central axis 32 of the crankshaft 30. As shown in FIG. 19, the cover 21 is housed inside the bottom bracket 26 having a hollow cylindrical shape and is fixed to the inside of the bottom bracket 26 by the screw members 27. Although the housing includes the cover 21 and the bottom bracket 26 in the present embodiment, the housing may have the cover 21 and the bottom bracket 26 integrally formed. In other words, it is acceptable to provide only the bottom bracket 26, without providing the cover 21.

FIG. 20 is a perspective view of the cover 21. As shown in FIG. 20, formed in outer circumferential parts at the right end and the left end of the cover 21 are uneven parts 211 and 212 to be fitted with the screw members 27. Further, formed in an inner circumferential part of the cover 21 is a spline part 213 to be fitted with the internal gear 532 of the planetary gear mechanism 53.

A method for fixing the cover 21 to the bottom bracket 26 will be described. As described above, the cover 21 is fixed to the inside of the bottom bracket 26 by the screw members 27. As shown in FIG. 19, the screw members 27 are each a tubular member positioned coaxially with the cover 21, and comprise a left screw member 27A to be fitted with the left end of the cover 21 and a right screw member 27B to be fitted with the right end of the cover 21. The screw members 27 are non-rotatably fixed to the cover 21, by being fitted with the uneven parts 211 and 212 provided at the ends of the outer circumferential parts of the cover 21. With this configuration, the internal gear 532 of the planetary gear mechanism 53 provided inside the cover 21 does not rotate relative to the bottom bracket 26 and the frame 2 (see FIG. 1).

Buffers 28 may preferably be provided between the cover 21 and the left screw member 27A as well as the right screw member 27B. A ring made of resin or an elastic adhesive agent may be used as each of the buffers 28, for example. By providing the buffers 28, it is possible to prevent squeaking noise that is caused when the cover 21 comes into contact with the screw members 27.

The left screw member 27A and the right screw member 27B are fixed to the bottom bracket 26 by screws. In this situation, the left screw member 27A may preferably have a screw thread of a right-hand screw formed thereon, whereas the right screw member 27B may preferably have a screw thread of a left-hand screw formed thereon. With this configuration, when the motor shaft 44 of the motor 40 rotates, counterforce in the direction to tighten the screws is exerted from the internal gear 532 of the planetary gear mechanism 53. As a result, because the screws fixing the bottom bracket 26 and the screw members 27 together do not become loose, it is possible to firmly fix the drive unit 20C to the bottom bracket 26.

### Third Embodiment

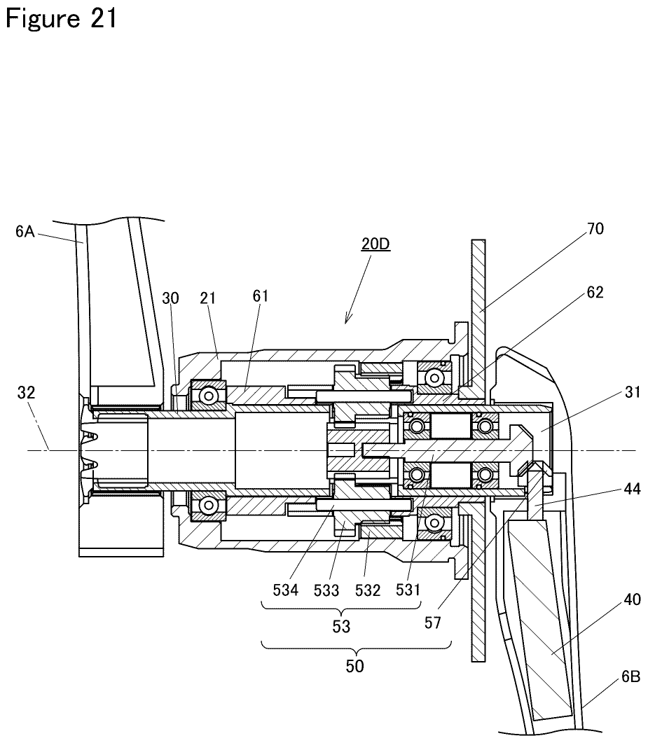

Next, a drive unit 20D according to a third embodiment will be described, with reference to FIG. 21. In the following sections, differences from the first and the second embodiments will primarily be described, and some of the constituent elements that are the same or similar will be referred to by using the same reference signs.

FIG. 21 is an enlarged view of the vicinity of the crankshaft 30 of the drive unit 20D. As shown in FIG. 21, the drive unit 20D comprises the cover 21, the crankshaft 30, the crank arms 6, the motor 40, the motive power transmission mechanism 50, the human power transmitter 61, the output element 62, and the front sprocket 70. The motive power transmission path is the same as that in the first embodiment. Although being provided with the human power transmitter 61 and the output element 62, the drive unit 20D does not necessarily need to be provided with the human power transmitter 61 and the output element 62, as shown with the drive unit 20C (see FIG. 18) in the second embodiment.

The motor 40 comprises the motor shaft 44. The motor 40 is housed inside the right crank arm 6B, in such a manner that the central axis of the motor shaft 44 extends in a direction orthogonal to the central axis 32 of the crankshaft 30. With this configuration, it is possible to make the motor 40 larger in size and to realize a high output. Further, the motor 40 is provided so that the motor shaft 44 overlaps with the crankshaft 30, in a lateral view of the electric assist bicycle 1. With this configuration, it is possible to miniaturize the drive unit 20D. Further, formed at the tip end of the motor shaft 44 is a teeth part that engages with a bevel gear 57 (described later). In the situation where the motor 40 is housed in a crank arm 6, the outside diameter of the motor 40 may ideally be greater than or equal to 60 mm and less than or equal to 110 mm approximately, from the perspective of miniaturization.

The motive power transmission mechanism 50 comprises the bevel gear 57 and the planetary gear mechanism 53. By providing the bevel gear 57, it is possible to transmit the rotation force of the motor 40 to the sun gear 531 positioned coaxially with the direction of the central axis 32 of the crankshaft 30. Further, as shown in FIG. 21, at least a part of the bevel gear 57 is housed in the hollow part 31 of the crankshaft 30. With this configuration, it is possible to miniaturize the drive unit 20D.

The planetary gear mechanism 53 comprises: the sun gear 531 being an external gear; the internal gear 532 positioned concentrically with the sun gear 531; at least one stepped planetary gear 533; and a plurality of planetary gear shafts 534.

The sun gear 531 is an input shaft of the planetary gear mechanism 53. The internal gear 532 is non-rotatably fixed to the cover 21, by being fitted with an inner circumferential part of the cover 21. The stepped planetary gear 533 engages with either the sun gear 531 or the internal gear 532. The planetary gear shafts 534 rotatably hold the four planetary gears 513, respectively. Further, the two ends of the planetary gear shafts 534 are inserted into the output element 62. With this configuration, the rotation force of the motor 40 is output to the output element 62 via the planetary gear mechanism 53, so that the output element 62 rotates.

### Fourth Embodiment

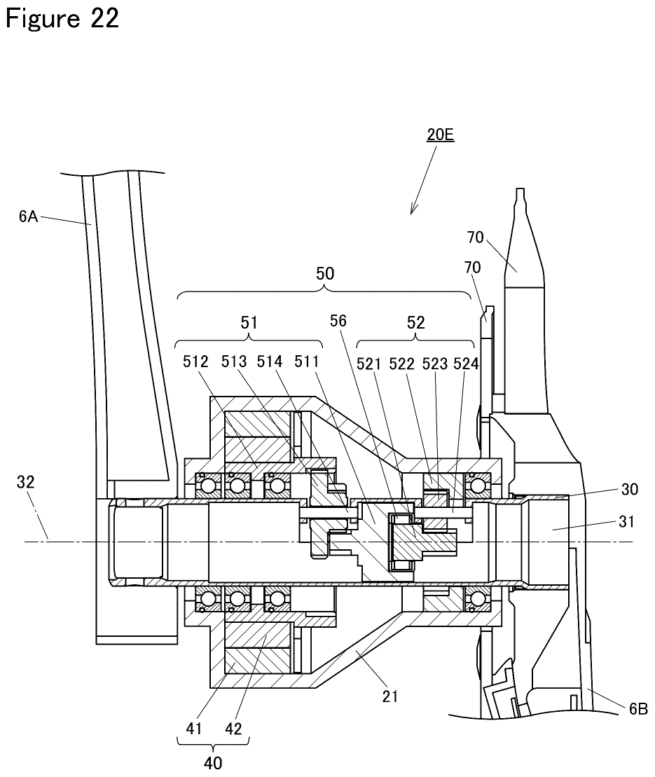

Next, a drive unit 20E according to a fourth embodiment will be described, with reference to FIG. 22. In the following sections, differences from the first to the third embodiments will primarily be described, and some of the constituent elements that are the same or similar will be referred to by using the same reference signs.

FIG. 22 is an enlarged view of the vicinity of the crankshaft 30 in the drive unit 20E. As shown in FIG. 22, the drive unit 20E includes the cover 21, the crankshaft 30, the crank arms 6, the motor 40, the motive power transmission mechanism 50, and the front sprocket 70. The motive power transmission path is the same as that in the second embodiment. It is also acceptable to provide the human power transmitter 61 and the output element 62, as shown in the drive unit 20A (see FIG. 2) in the first embodiment.

The motor 40 comprises the stator 41 and the rotor 42. The motor 40 is housed in the cover 21 and is provided on the radially outer side of the crankshaft 30. With this configuration, it is possible to allow the motor 40 to have a large diameter and to thus realize high outputs.

The stator 41 is fixed to an inner circumferential part of the cover 21 by a press-fit or the like. The diameter of the stator 41 may preferably be formed to be greater than or equal to 50 mm and less than or equal to 150 mm, from the perspective of realizing both the miniaturization of the drive unit 20E and the high outputs of the motor 40.

The rotor 42 is provided on the inside of the stator 41 and rotates on the central axis 32 of the crankshaft 30. Further, the rotor 42 has a serration or the like formed on an inner circumferential part thereof and engages with a teeth part provided on the outer circumference of the internal gear 512 of the first planetary gear mechanism 51. As a result, when the rotor 42 rotates, the internal gear 512 of the first planetary gear mechanism 51 rotates.

The motive power transmission mechanism 50 includes the first planetary gear mechanism 51, the second planetary gear mechanism 52, and the one-way clutch 56.

The first planetary gear mechanism 51 comprises: the sun gear 511 being an external gear; the internal gear 512 positioned concentrically with the sun gear 511 and having teeth parts formed on the inside and the outside thereof, a plurality of planetary gears 513; and a plurality of planetary gear shafts 514.

The sun gear 511 is an output shaft of the first planetary gear mechanism 51. The internal gear 512 is an input shaft of the first planetary gear mechanism 51 and rotates in conjunction with the rotation of the rotor 42. The planetary gears 513 engage with the sun gear 511 and also engage with the internal gear 512. The planetary gear shafts 514 rotatably hold the plurality of planetary gears 513, respectively. Further, the two ends of the planetary gear shafts 514 are inserted in the crankshaft 30. In other words, the planetary gear shafts 514 are non-rotatably fixed to the crankshaft 30. With this configuration, the rotation force of the motor 40 is output to the sun gear 511 via the first planetary gear mechanism 51.

The one-way clutch 56 is provided between the sun gear 511 of the first planetary gear mechanism 51 and the sun gear 521 of the second planetary gear mechanism 52. With this configuration, the rotation force of the motor 40 is transmitted from the sun gear 511 being an output shaft of the first planetary gear mechanism 51 to the sun gear 521 of the second planetary gear mechanism 52, via the one-way clutch 56.

The second planetary gear mechanism 52 comprises the sun gear 521 being an external gear, the internal gear 522 positioned concentrically with the sun gear 521; a plurality of planetary gears 523; and a plurality of planetary gear shafts 524.

The sun gear 521 is an input shaft of the second planetary gear mechanism 52. The internal gear 522 is non-rotatably fixed to the cover 21, by being fitted with an inner circumferential part of the cover 21. The planetary gears 523 engage with the sun gear 521 and also engage with the internal gear 522. The planetary gear shafts 524 rotatably hold the four planetary gears 523, respectively. Further, the two ends of the planetary gear shafts 524 are inserted in the crankshaft 30. With this configuration, the rotation force of the motor 40 is output to the crankshaft 30, via the second planetary gear mechanism 52.

### Fifth Embodiment

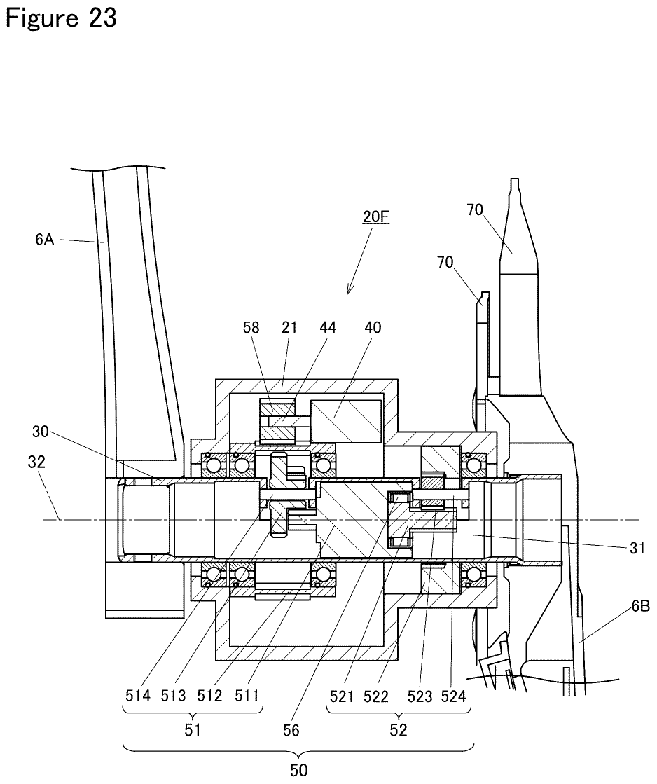

Next, a drive unit 20F according to a fifth embodiment will be described, with reference to FIG. 23. In the following sections, differences from the first to the fourth embodiments will primarily be described, and some of the constituent elements that are the same or similar will be referred to by using the same reference signs.

FIG. 23 is an enlarged view of the vicinity of the crankshaft 30 of the drive unit 20F. As shown in FIG. 23, the drive unit 20F includes the cover 21, the crankshaft 30, the crank arms 6, the motor 40, the motive power transmission mechanism 50, and the front sprocket 70. The motive power transmission path is the same as that in the second and the fourth embodiments. Further, it is also acceptable to provide the human power transmitter 61 and the output element 62, as shown in the drive unit 20A (see FIG. 2) in the first embodiment.

The motor 40 comprises the motor shaft 44. The motor 40 is housed in the cover 21 and is provided on the radially outer side of the crankshaft 30. The central axis of the motor shaft 44 extends parallel to the central axis 32 of the crankshaft 30. A pinion gear 58 is provided at a tip end of the motor shaft 44. The pinion gear 58 engages with a teeth part formed in an outer circumferential part of the internal gear 512 of the first planetary gear mechanism 51. With this configuration, when the motor shaft 44 rotates, the internal gear 512 of the first planetary gear mechanism 51 rotates. Alternatively, instead of providing the pinion gear 58, it is also acceptable to cause the internal gear 512 to rotate, by forming, at a tip end of the motor shaft 44, a teeth part that engages with an outer circumferential part of the internal gear 512. Further, it is also acceptable to provide a motive power transmission mechanism such as a planetary gear mechanism between the motor shaft 44 and an outer circumferential part of the internal gear 512.

The motive power transmission mechanism 50 includes the first planetary gear mechanism 51, the second planetary gear mechanism 52, and the one-way clutch 56.

The first planetary gear mechanism 51 comprises: the sun gear 511 being an external gear; the internal gear 512 positioned concentrically with the sun gear 511 and having teeth parts formed on the inside and the outside thereof, a plurality of planetary gears 513; and a plurality of planetary gear shafts 514.

The sun gear 511 is an output shaft of the first planetary gear mechanism 51. The internal gear 512 is an input shaft of the first planetary gear mechanism 51 and rotates in conjunction with the rotation of the motor shaft 44. The planetary gears 513 engage with the sun gear 511 and also engage with the internal gear 512. The planetary gear shafts 514 rotatably hold the plurality of planetary gears 513, respectively. Further, the two ends of the planetary gear shafts 514 are inserted in the crankshaft 30. In other words, the planetary gear shafts 514 are non-rotatably fixed to the crankshaft 30. With this configuration, the rotation force of the motor 40 is output to the sun gear 511 via the first planetary gear mechanism 51.

The one-way clutch 56 is provided between the sun gear 511 of the first planetary gear mechanism 51 and the sun gear 521 of the second planetary gear mechanism 52. With this configuration, the rotation force of the motor 40 is transmitted from the sun gear, 511 being an output shaft of the first planetary gear mechanism 51, to the sun gear 521 of the second planetary gear mechanism 52, via the one-way clutch 56.

The second planetary gear mechanism 52 comprises: the sun gear 521 being an external gear, the internal gear 522 positioned concentrically with the sun gear 521; a plurality of planetary gears 523; and a plurality of planetary gear shafts 524.

The sun gear 521 is an input shaft of the second planetary gear mechanism 52. The internal gear 522 is non-rotatably fixed to the cover 21, by being fitted with an inner circumferential part of the cover 21. The planetary gear 523 engages with the sun gear 521 and also engages with the internal gear 522. The planetary gear shafts 524 rotatably hold the four planetary gears 523, respectively. Further, the two ends of the planetary gear shafts 524 are inserted in the crankshaft 30. With this configuration, the rotation force of the motor 40 is output to the crankshaft 30, via the second planetary gear mechanism 52.

### Sixth Embodiment

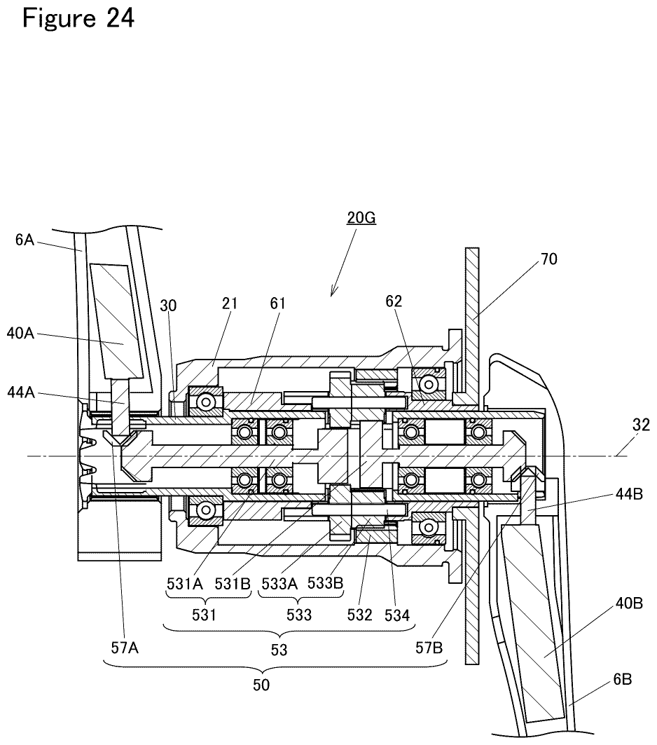

Next, a drive unit 20G according to a sixth embodiment will be described, with reference to FIG. 24. In the following sections, differences from the first to the fifth embodiments will primarily be described, and some of the constituent elements that are the same or similar will be referred to by using the same reference signs.

FIG. 24 is an enlarged view of the vicinity of the crankshaft 30 of the drive unit 20G. As shown in FIG. 24, the drive unit 20G comprises the cover 21, the crankshaft 30, the crank arms 6, the motor 40, the motive power transmission mechanism 50, the human power transmitter 61, the output element 62, and the front sprocket 70. The motive power transmission path is the same as that in the first and the third embodiments. Although being provided with the human power transmitter 61 and the output element 62, the drive unit 20G does not necessarily need to be provided with the human power transmitter 61 and the output element 62, as shown with the drive unit 20C (see FIG. 18) of the second embodiment.

The motor 40 comprises a first motor 40A and a second motor 40B. The first motor 40A is housed in the left crank arm 6A, whereas the second motor 40B is housed in the right crank arm 6B. The torque levels output by the first motor 40A and the second motor 40B may be mutually the same or may be mutually different.

The first motor 40A comprises a first motor shaft 44A, whereas the second motor 40B comprises a second motor shaft 44B. The central axis of the first motor shaft 44A and the central axis of the second motor shaft 44B are each positioned so as to extend in a direction orthogonal to the central axis 32 of the crankshaft 30. Further, formed at a tip end of each of the first motor shaft 44A and the second motor shaft 44B is a teeth part that engages with the bevel gear 57 (described later).

The motive power transmission mechanism 50 comprises the bevel gear 57 and the planetary gear mechanism 53. The bevel gear 57 comprises a first bevel gear 57A that engages with the first motor shaft 44A and a second bevel gear 57B that engages with the second motor shaft 44B. By providing the bevel gear 57, it is possible to convert the rotation force of the motor 40 into force in the direction of the central axis 32 of the crankshaft 30.

The planetary gear mechanism 53 comprises: the sun gear 531; the internal gear 532 positioned concentrically with the sun gear 531; a plurality of stepped planetary gears 533; and a plurality of planetary gear shafts 534.

The sun gear 531 is an input shaft of the planetary gear mechanism 53 and comprises a first sun gear 531A and a second sun gear 531B. The first sun gear 531A engages with the first bevel gear 57A, so that the rotation force of the first motor 40A is transmitted. The second sun gear 531B engages with the second bevel gear 57B, so that the rotation force of the second motor 40B is transmitted. The internal gear 532 is non-rotatably fixed to the cover 21, by being fitted with an inner circumferential part of the cover 21.

The stepped planetary gears 533 comprises: a first planetary gear 533A that engages with the first sun gear 531A and the internal gear 532; and a second planetary gear 533B that engages with the second sun gear 531B and the internal gear 532. In this situation, the number of teeth on the first planetary gear 532A may preferably be different from the number of teeth on the second planetary gear 532B. For example, if the number of teeth on the first planetary gear 533A was larger than the number of teeth on the second planetary gear 533B, an output of the first motor 40A would be decelerated more than an output of the second motor 40B. With the above configuration, it is possible to realize a low-speed rotation and high torque by driving only the first motor 40A and to realize a high-speed rotation and low torque by driving only the second motor 40B. Further, it is also acceptable to provide, together therewith, a control system that controls the rotations of the motors 40, in accordance with vehicle speeds and slope climbing situations of the electric assist bicycle 1.

The planetary gear shafts 534 rotatably hold the four planetary gears 513, respectively. Further, the two ends of the planetary gear shafts 534 are inserted into the output element 62. With this configuration, the rotation force of the motor 40 is output to the output element 620 via the planetary gear mechanism 53.

### REFERENCE SIGNS LIST

1 Electric assist bicycle, 2 Frame, 2A Head pipe, 2B Front fork, 2C Top pipe, 2D Down pipe, 2E Seat pipe, 2F Seat stay, 2G Chain stay, 3 Wheel, 3A Front wheel, 3B Rear wheel, 4 Handlebar, 5 Saddle, 6 Crank arm, 6A Left crank arm, 6A1 Inner part, 6A2 Outer part, 6B Right crank arm, 7 Pedal, 8 Chain, 9 Front light, 10 Electric power storage device, 11 Rear wheel sprocket, 20, 20A, 20B, 20C, 20D, 20E, 20F, 20G Drive unit, 21 Cover, 22, 23, 24 Bearing, 25 Insertion hole, 26 Bottom bracket, 27 Screw member, 27A Left screw member, 27B Right screw member, 28 Buffer, 30 Crankshaft, 31 Hollow part, 32 Central axis, 33 Lock ring, 35 Crank groove, 36 Spline part, 37 Through hole, 40 Motor, 41 Stator, 42 Rotor, 44 Motor shaft, 50 Motive power transmission mechanism, 51 First planetary gear mechanism, 52 Second planetary gear mechanism, 53 Planetary gear mechanism, 56 One-way clutch, 57 Bevel gear, 58 Pinion gear, 61 Human power transmitter, 62 Output element, 70 Front sprocket, 71 Spider arm, 80 Torque sensor, 90 Energization unit, 91 Rotation part, 92 Brush unit, 93 Slip ring, 94 Brush, 100 Control device, 101 Energization member, 102 Heat dissipation part, 103 Heat conductor, 105 Motor rotation detection substrate, 106 crankshaft rotation detection substrate, 107 Magnet, 108 Motor terminal, 111 Insertion part, 112 Protrusion hole, 114 Insertion hole, 115 Fixation hole, 117 Bolt, 118 Cutout, 120 Fixation component part, 121 Protrusion part, 211, 212 Uneven part, 213 Spline part, 511, 521, 531 Sun gear, 512, 522, 532 Internal gear, 513, 523, 533 Planetary gear, 514, 524, 534 Planetary gear shaft, 515 Planetary carrier, 611, 612, 621, 624 Spline part, 613 Human power transmitter groove, 622 Through hole, 623 Insertion hole

1. A drive unit used in an electric vehicle, comprising:
a motor;
a housing;
a crankshaft that protrudes from the housing and is rotatably attached to the housing;
an output element that outputs rotation force of the motor; and
a motive power transmission mechanism that transmits the rotation force of the motor to the output element, wherein
the crankshaft has a hollow part, and
at least a part of the motive power transmission mechanism is housed in the hollow part.

2. The drive unit according to claim 1, wherein
the output element rotates together with the crankshaft.

3. The drive unit according to claim 1, wherein
the output element is rotatably attached to the crankshaft.

4. The drive unit according to claim 1, wherein
the motor includes a motor shaft, and
a central axis of the motor shaft is positioned coaxially with a central axis of the crankshaft.

5. The drive unit according to claim 1, wherein
the motor includes a motor shaft,
a central axis of the motor shaft is positioned so as to extend in a direction intersecting a central axis of the crankshaft, and
at least a part of the motor shaft overlaps with the crankshaft in a lateral view of the electric vehicle.

6. The drive unit according to claim 1, further comprising:
an energization unit that supplies electric power to the motor, wherein
the energization unit comprises:
an electric power reception part into which the crankshaft is inserted; and
an electric power supply part that rotates relative to the electric power reception part and supplies electric power to the electric power reception part.

7. The drive unit according to claim 6, wherein
the electric power is supplied from the electric power supply part to the electric power reception part by using a contact electric power supply scheme.

8. The drive unit according to claim 7, wherein
the electric power reception part includes a slip ring, and
the electric power supply part slidably abuts against the slip ring and includes a brush unit having a brush that supplies electric power to the slip ring.

9. The drive unit according to claim 6, wherein
the electric power is supplied from the electric power supply part to the electric power reception part by using a contactless electric power supply scheme.

10. The drive unit according to claim 1, further comprising:
a pair of crank arms to each of which a pedal is attached; and
a torque sensor that detects human driving force applied to the crankshaft, wherein
the pair of crank arms are connected to two ends of the crankshaft,
the crankshaft is rotated by the human driving force applied to the pedals, and
the torque sensor is provided for at least one of the crank arms.

11. The drive unit according to claim 1, further comprising:
a pair of crank arms to each of which a pedal is attached;
a torque sensor that detects human driving force applied to the crankshaft; and
a control device that controls the rotation force of the motor based on detection information from the torque sensor, wherein
the pair of crank arms are connected to two ends of the crankshaft, and
the torque sensor is provided on a radially outer side of the crankshaft.

12. The drive unit according claim 1, wherein
the motive power transmission mechanism includes a planetary gear mechanism comprising a sun gear, a planetary carrier, and an internal gear.

13. The drive unit according to claim 12, wherein
at least a part of the sun gear is housed in the hollow part.

14. The drive unit according to claim 12, wherein
the internal gear is non-rotatably fixed.

15. The drive unit according to claim 12, wherein
the planetary carrier is non-rotatably fixed.

16. The drive unit according to claim 12, wherein
the motive power transmission mechanism includes two or more planetary gear mechanisms each comprising a sun gear, a planetary gear, and an internal gear.

17. The drive unit according to claim 12, wherein
the planetary gear mechanism includes: a first planetary gear that engages with the sun gear; and a second planetary gear having a diameter smaller than that of the first planetary gear.

18. The drive unit according to claim 12, wherein
the motive power transmission mechanism includes at least one one-way clutch.

19. The drive unit according to claim 18, wherein
at least a part of the one-way clutch is housed in the hollow part.

20. The drive unit according to claim 18, wherein
the motive power transmission mechanism includes a planetary gear mechanism comprising a sun gear, a planetary carrier, and an internal gear,
the planetary gear mechanism includes: a first planetary gear that engages with the sun gear; and a second planetary gear having a diameter smaller than that of the first planetary gear, and
the one-way clutch is included between the first planetary gear and the second planetary gear.

21. The drive unit according to claim 18, wherein
the motive power transmission mechanism includes two or more one-way clutches.

22. The drive unit according to claim 1, wherein
the motive power transmission mechanism includes a bevel gear or a hypoid gear.

23. The drive unit according to claim 1, wherein
at least a part of the motor is housed in the hollow part.

24. The drive unit according to claim 1, wherein
the motor is housed in the housing and is provided on a radially outer side of the crankshaft.

25. The drive unit according to claim 1, further comprising:
a pair of crank arms to each of which a pedal is attached, wherein
the pair of crank arms are connected to two ends of the crankshaft, and
at least a part of the motor is housed inside at least one of the crank arms.

26. The drive unit according to claim 1, further comprising:
a pair of crank arms to each of which a pedal is attached, wherein
the pair of crank arms are connected to two ends of the crankshaft, and
one or both of the crank arms and the pedals have installed therein an electric power storage device.

27. The drive unit according to claim 1, wherein
the motor includes a first motor and a second motor.

28. The drive unit according to claim 1, further comprising:
a pair of crank arms to each of which a pedal is attached and in each of which an insertion hole for having the crankshaft inserted is formed, wherein
at least one of the pair of crank arms is provided, in an attachable/detachable manner, with a fixation component part that has a protrusion part protruding toward an inside of the insertion hole, and that is used for fixing the crankshaft to the crank arm.

29. The drive unit according to claim 6, wherein
the crankshaft has a crank groove that has a recessed shape and is formed in a part of an outer circumferential part of the crankshaft, and
an energization member extending from the energization unit passes through the crank groove.

30. The drive unit according to claim 1, wherein
the housing includes a bottom bracket, a tubular cover, and a screw member that fixes the cover to an inside of the bottom bracket, and
a buffer is provided between the cover and the screw member.

31. The drive unit according to claim 30, wherein
the screw member includes:
a right screw member that, as viewed from a rear side of the electric vehicle, connects a right end of the cover to the bottom bracket; and
a left screw member that, as viewed from the rear side of the electric vehicle, connects a left end of the cover to the bottom bracket,
the right screw member has a left screw structure, and
the left screw member has a right screw structure.

32. A drive unit used in an electric vehicle, comprising:
a motor;
a housing;
a crankshaft that protrudes from the housing and is rotatably attached to the housing;
an output element that outputs rotation force of the motor; and
a motive power transmission mechanism that transmits the rotation force of the motor to the output element, wherein
the motive power transmission mechanism includes a first one-way clutch and a second one-way clutch, and
rotation axes of the first one-way clutch and the second one-way clutch are the same.

33. An electric vehicle comprising the drive unit according to claim 1.
